(19) United States
(12) Patent Application Publication
(10) Pub. No.: US 2017/0019853 A1
(43) Pub. Date: Jan. 19, 2017

(54) POWER SAVING ARCHITECTURES AND TECHNIQUES IN WIRELESS NETWORKS

(71) Applicant: Intel Corporation, Santa Clara, CA (US)

(72) Inventors: Chittabrata Ghosh, Fremont, CA (US); Yaron Alpert, Petah Tikva (IL)

(21) Appl. No.: 14/998,188

(22) Filed: Dec. 26, 2015

Related U.S. Application Data
(60) Provisional application No. 62/192,402, filed on Jul. 14, 2015.

(51) Int. Cl. H04W 52/02

(52) U.S. Cl. CPC H04W 52/0216

(57) ABSTRACT

Architectures and techniques for power saving in densely deployed wireless networks are provided. An example system includes an access point device and devices wirelessly coupled to the access point device. The access point device may broadcast its availability schedule to the one or more devices, and the devices may transmit their availability schedule to the access point or to another device. The access point and the one or more devices may negotiate a short term and a long term availability schedule such that their sleep times and wake up times are synchronized, thereby saving power for the device as well as the access point. Each access point may be wirelessly connected to one or more devices, and each device may be wirelessly connected to one or more access points and/or one or more devices within a wireless network.

### CROSS-REFERENCE TO RELATED PATENT APPLICATION

The present application is related to and claims priority from U.S. Provisional Patent Application No. 62/192,402, filed Jul. 14, 2015, which application is hereby incorporated by reference herein in its entirety.

### BACKGROUND

In the realm of Internet of Things (IoT), some sensors can form the lower tier of the hierarchical network architecture. These battery-constrained sensors can be designed to measure a defined parameter, e.g., pressure, humidity, temperature, motion, and so forth. A small number of location-specific sensors can be connected to low-power sensor hub devices. Several such sensor hubs can connect to a defined group of sensors. An access gateway device can connect to multiple such sensor hub devices and can upload collected data to a remote server. At least some low-power device within the realm of Internet of Things (IoT) can be expected to consume, for example, low average power in order to perform a frame exchange with sensor hub devices within a densely deployed wireless network, e.g., a wireless local area network (WLAN). As such, Institute of Electrical and Electronics Engineers (IEEE) 802.11 ax protocol (or High Efficiency Wireless (HEW)) can introduce a target wake time (TWT) where sensor nodes (e.g., sensors in a HEW network) can negotiate or can be assigned estimated wakeup periods during association by an access gateway device. As an example, temperature sensors may wake up in the morning hours, every one hour, while motion sensors may wake up every ten minutes in a smart home.

### BRIEF DESCRIPTION OF THE DRAWINGS

The accompanying drawings form an integral part of the disclosure and are incorporated into the present specification. The drawings illustrate example embodiments of the disclosure and, in conjunction with the description and claims, serve to explain at least in part various principles, features, or aspects of the disclosure. Certain embodiments of the disclosure are described more fully below with reference to the accompanying drawings. However, various aspects of the disclosure can be implemented in many different forms and should not be construed as limited to the implementations set forth herein. Like numbers refer to like elements throughout.

FIG. 1 presents an example of an operational environment for wireless communication in accordance with one or more embodiments of the disclosure.

FIG. 2 presents an example of a network environment in accordance with one or more embodiments of the disclosure.

FIG. 3 presents another example of an operational environment for wireless communication in accordance with or more embodiments of the disclosure.

FIG. 4 presents examples of availability schedules in accordance with one or more embodiments of the disclosure.

FIG. 5A presents an example of a device in accordance with one or more embodiments of the disclosure.

FIG. 5B presents an example of a radio unit for wireless communication in accordance with one or more embodiments of the disclosure.

FIG. 6 presents an example of an apparatus in accordance with one or more embodiments of the disclosure.

FIG. 7 presents an example of power-saving operation in a wireless network in accordance with one or more embodiments of the disclosure.

FIG. 8 presents another example of an apparatus in accordance with one or more embodiments of the disclosure.

FIGS. 9, 10, and 11 present other examples of power-saving operation in a wireless network in accordance with one or more embodiments of the disclosure.

FIG. 12 presents another example of an apparatus in accordance with one or more embodiments of the disclosure.

FIG. 13 presents an example of a computational environment for wireless communication in accordance with one or more embodiments of the disclosure.

FIG. 14 presents another example of a device for wireless communication in accordance with one or more embodiments of the disclosure.

### DETAILED DESCRIPTION

The disclosure recognizes and addresses, in at least some embodiments, the issue of low-power consumption in the operation of devices in a densely deployed wireless network. Numerous low-power wireless networks having network elements communicating wirelessly or otherwise. An example of such networks is a Thread network, which embodies a mesh network that operates according to Thread protocols. Specifically, Thread is a new mesh network communications standard that is undergoing definition in the Thread Group with an initial, non-limiting focus on the smart home market. The Thread Physical layer operates in the 2.4 GHz frequency band and is based on IEEE 802.15.4 PHY and MAC specification. Another example of a low-power network is mesh network that operates Wi-Fi Aware™, which also may be referred to as neighbor awareness networking (NAN). Such a mesh network can be referred to as a NAN wireless network. Clusters of devices can be formed in a NAN wireless network, where a device in a cluster can discover devices and/or services according to a common awake-time scheduled (e.g. a discovery window). More specifically, devices in a cluster can be synchronized to a same clock, and can converge on a time interval (e.g., a discovery window) and communication channel in order to permit the discovery of each other's services. In addition, a NAN data cluster (NDC) having data paths and/or data links can be formed (e.g., defined logically) on top of an existing NAN cluster. Devices that pertain to an NDC also can have a common base schedule for device and/or service discovery, e.g., a discovery window or another type of awake-time schedule. In some scenarios, each (or, in some instances, at least one) device in an NDC can have dynamic resources constraints, which can preclude or otherwise make difficult a common base schedule. Further or in other scenarios, the common base schedule can be updated in order to accommodate such constraints. The signaling associated with such updates increases with the size of an NDC.

As described in greater detail below, the disclosure provides, among other things, devices, systems, techniques, and/or computer program products for power-saving operation of network elements in a wireless network. Some embodiments of the disclosure can permit the implementation of low-power consumption for access gateway devices in IoT applications, for example. As an illustration, in a smart home with sensors reporting various types of data every hour synchronously, the sensor hub devices or the access gateway devices may remain in sleep mode and wake up every one hour to collect the data. This disclosure describes methods, apparatus, and systems for power saving in densely deployed wireless networks. An example system includes an access point and one or more devices that can be wirelessly coupled to the access point (AP) device. The AP can broadcast its availability schedule to the one or more devices, which may include sleep times and wakeup times of the access point. In response, at least one of the devices can transmit their availability schedule to the access point or to another device, which may include sleep times and wakeup times of the devices. The access point device and the one or more devices may negotiate a short term and a long term availability schedule such that their sleep times and wake up times are synchronized, thereby saving power for the device as well as the access point device. Each access point device can be wirelessly coupled to one or more devices, and each device can be wirelessly coupled to one or more AP devices and/or one or more devices within a wireless network.

A design target for HEW is to adopt methods to improve the efficiency of Wi-Fi, and specifically the efficiency in dense deployments of Wi-Fi devices, such as in malls, conference halls, smart homes etc. HEW can utilize or otherwise leverage orthogonal frequency-division multiple access (OFDMA) techniques for channel access in the uplink and downlink directions. It is understood that the uplink direction is from an IoT device to an AP, and the downlink direction is from an AP device to IoT devices. In the uplink direction, one or more IoT devices can communicate with the AP device and can compete (e.g., contend) for channel access in a random channel access manner. In that case, the channel access in OFDMA can require coordination among the various IoT devices that can be competing to access the operating channel simultaneously or essentially simultaneously. In some embodiments, a trigger frame can include a preamble and/or other information (e.g., signaling, such as a resource allocation) to coordinate the uplink OFDMA operation. As such, a trigger frame can be embodied in or can include a frame that contains a preamble and other field(s) that can be sent from an AP device informing all (or, in some embodiments, at least some) IoT devices serviced by the AP device that channel access is available.

In some aspects, within OFDMA, an AP device can transmit a trigger frame that can allocate resources. For instance, the allocated resources can correspond to a narrow portion 8 (e.g., 2 MHz) of frequency spectrum within a communication channel having spectral bandwidth Δ>δ. Such an allocation can be referred to as a narrowband allocation. In the present disclosure, in some examples, A can be approximately equal to one of 20 MHz, 40 MHz, 60 MHz, 80 MHz, or (80+80) MHz. Individual station devices, such as a user device or a customer premises equipment (CPE), can utilize or otherwise leverage the allocated resources to transmit data to the AP device. Therefore, in some aspects of such an access approach, a station device can only transmit information (e.g., data and/or signaling) within a narrow spectral bandwidth in response to the trigger frame. In addition, the AP device may be unaware of which station devices or how many station devices have data to send.

The terminology “access point device” (AP device) as used herein can refer to a stationary device or a mobile device. An access point device may also be referred to as an access node, an access gateway device, an IoT gateway device, a sensor hub device, a base station device, or some other similar terminology. An access terminal may also be called a station device (mobile or otherwise), a user equipment (UE), a customer premises equipment, a wireless communication device, or some other similar terminology. Embodiments disclosed herein generally pertain to wireless networks. Some embodiments can relate to wireless networks that operate in accordance with one or more of the IEEE 802.11 standards.

Some embodiments may be used in conjunction with various devices and systems, for example, a personal computer (PC), a desktop computer, a mobile computer, a laptop computer, a notebook computer, a tablet computer, a server computer, a handheld computer, a handheld device, a personal digital assistant (PDA) device, a handheld PDA device, an on-board device, an off-board device, a hybrid device, a vehicular device, a non-vehicular device, a mobile or portable device, a consumer device, a non-mobile or non-portable device, a wireless communication station, a wireless communication device, a wireless access point (AP) device, a wireline or wireless router device, a wireline or wireless modem device, a video device, an audio device, an audio-video (AN) device, a network node or a wiredline or wireless network, a wireless area network, a wireless video area network (WVAN), a local area network (LAN), a WLAN, a personal area network (PAN), a wireless PAN (WPAN), and the like.

Some embodiments of this disclosure may be implemented in conjunction with one-way and/or two-way radio communication systems, cellular radio-telephone communication systems, a mobile phone, a cellular telephone, a wireless telephone, a personal communication systems (PCS) device, a PDA device which incorporates a wireless communication device, a mobile or portable global positioning system (GPS) device, a device which incorporates a GPS receiver or transceiver or chip, a device which incorporates a radio frequency identification (RFID) element or chip, a multiple input multiple output (MIMO) transceiver or device, a single input multiple output (SIMO) transceiver or device, a multiple input single output (MISO) transceiver or device, a device having one or more internal antennas and/or external antennas, digital video broadcast (DVB) devices or systems, multi-standard radio devices or systems, a wired or wireless handheld device, e.g., a smartphone, a wireless application protocol (WAP) device, or the like.

Some embodiments may be used in conjunction with one or more types of wireless communication signals and/or systems following one or more wireless communication protocols, for example, radio frequency (RF), infrared (IR), frequency-division multiplexing (FDM), orthogonal FDM (OFDM), time-division multiplexing (TDM), time-division multiple access (TDMA), extended TDMA (E-TDMA), general packet radio service (GPRS), extended GPRS, code-division multiple access (CDMA), wideband CDMA (WCDMA), CDMA 2000, single-carrier CDMA, multi-carrier CDMA, multi-carrier modulation (MCM), discrete multi-tone (DMT), Bluetooth®, global positioning system (GPS), Wi-Fi, Wi-Max, ZigBee™, ultra-wideband (UWB), global system for mobile communication (GSM), 2G, 2.5G, 3G, 3.5G, 4G, fifth generation (5G) mobile networks, 3GPP, long term evolution (LTE), LTE advanced, enhanced data rates for GSM evolution (EDGE), or the like. Other embodiments may be used in various other devices, systems, and/or networks.

While various embodiments of the disclosure are illustrated in connection with a network that operates according to Tread network protocols, it is noted that disclosure is not limited in this respect and embodiments of the disclosure can be implemented in any low-power network having devices that operate at low power and can transition between a power-sleep mode (or low-power mode) to a power-awake mode (or high-power mode) during operation within the network. Further, the elements described herein in connection with power-saving operations in a low-power wireless network can be implemented in any type of low-power networks operating according to protocols for wireline communication and/or radio technology protocol for wireless communication, not just Thread protocols. Embodiments described herein provide certain systems, methods, and devices, for providing signaling information to Wi-Fi devices in various Wi-Fi networks, including, but not limited to, Wi-Fi Aware™, also referred to as neighbor awareness networking (NAN).

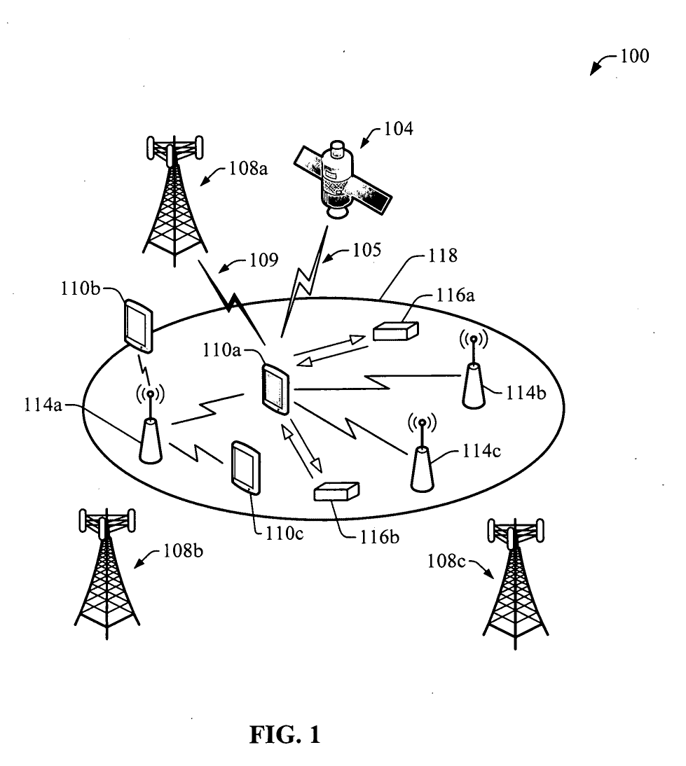

With reference to the drawings, FIG. 1 presents a block diagram of an example operational environment 100 for wireless communication in accordance with at least certain aspects of the disclosure. The operational environment 100 includes several telecommunication infrastructures and communication devices, which collectively can embody or otherwise constitute a telecommunication environment. More specifically, yet not exclusively, the telecommunication infrastructures can include a satellite system 104. As described herein, the satellite system 104 can be embodied in or can include a global navigation satellite system (GNSS), such as the Global Positioning System (GPS), Galileo, GLONASS (Globalnaya navigatsionnaya sputnikovaya sistema), BeiDou Navigation Satellite System (BDS), and/or the Quasi-Zenith Satellite System (QZSS). In addition, the telecommunication infrastructures can include a macro-cellular or large-cell system; which is represented with three base stations 108a-108c; a micro-cellular or small-cell system, which is represented with three access points (or low-power base stations) 114a-114c; and a sensor-based system—which can include proximity sensor(s), beacon device(s), pseudo-stationary device(s), and/or wearable device(s)—represented with functional elements 116a-116c. As illustrated, in one implementation, each of the transmitter(s), receiver(s), and/or transceiver(s) included in respective computing devices (such as telecommunication infrastructure) can be functionally coupled (e.g., communicatively or otherwise operationally coupled) with the wireless device 110a (also referred to as communication device 110a) via wireless link(s) in accordance with specific radio technology protocols (e.g., IEEE 802.11a, IEEE 802.11ax, etc.) in accordance with aspects of this disclosure. For another example, a base station (e.g., base station 108a) can be functionally coupled to the wireless devices 110a, 110b, and 110c via respective an upstream wireless link (UL) and a downstream link (DL) configured in accordance with a radio technology protocol for macro-cellular wireless communication (e.g., 3^{rd} Generation Partnership Project (3GPP) Universal Mobile Telecommunication System (UMTS) or “3G,” “3G”; 3GPP Long Term Evolution (LTE), or LTE); LTE Advanced (LTE-A)). For yet another example, an access point (e.g., access point (AP) device 114a) can be functionally coupled to one or more of the wireless devices 110a, 110b, or 110c via a respective UL and DL configured in accordance with a radio technology protocol for small-cell wireless communication (e.g., femtocell protocols, Wi-Fi, and the like). For still another example, a beacon device (e.g., device 116a) can be functionally coupled to the wireless device 110a with a UL-only (ULO), a DL-only, or an UL and DL, each of such wireless links (represented with open-head arrows) can be configured in accordance with a radio technology protocol for point-to-point or short-range wireless communication (e.g., Zigbee, Bluetooth, or near field communication (NFC) standards, ultrasonic communication protocols, or the like).

In the operational environment 100, the small-cell system and/or the beacon devices can be contained in a confined area 118 that can include an indoor region (e.g., a commercial facility, such as a shopping mall) and/or a spatially-confined outdoor region (such as an open or semi-open parking lot or garage). The small-cell system and/or the beacon devices can provide wireless service to a device (e.g., wireless device 110a or 110b) within the confined area 118. For instance, the wireless device 110a can handover from macro-cellular wireless service to wireless service provided by the small-cell system present within the confined area 118. Similarly, in certain scenarios, the macro-cellular system can provide wireless service to a device (e.g., the wireless device 110a) within the confined area 118.

In certain embodiments, the wireless device 110a, as well as other communication devices (wireless or wireline) contemplated in the present disclosure, can include electronic devices having computational resources, including processing resources (e.g., processor(s)), memory resources (memory devices (also referred to as memory), and communication resources for exchange of information within the computing device and/or with other computing devices. Such resources can have different levels of architectural complexity depending on specific device functionality. Exchange of information among computing devices in accordance with aspects of the disclosure can be performed wirelessly as described herein, and thus, in one aspect, the wireless device 110a also can be referred to as wireless communication device 110a, wireless computing device 110a, communication device 110a, or computing device 110a interchangeably. The same nomenclature considerations apply to wireless device 110b and wireless device 110c. More generally, in the present disclosure, a communication device can be referred to as a computing device and, in certain instances, the terminology “communication device” can be used interchangeably with the terminology “computing device,” unless context clearly dictates that a distinction should be made. In addition, a communication device (e.g., communication device 110a or 110b or 110c) that operates according to HEW can utilize or leverage a physical layer convergence protocol (PLCP) and related PLCP protocol data units (PPDUs) in order to transmit and/or receive wireless communications. Example of the computing devices that can communicate wirelessly in accordance with aspects of the present disclosure can include desktop computers with wireless communication resources; mobile computers, such as tablet computers, smartphones, notebook computers, laptop computers with wireless communication resources, Ultrabook™ computers; gaming consoles, mobile telephones; blade computers; programmable logic controllers; near field communication devices; customer premises equipment with wireless communication resources, such as set-top boxes, wireless routers, wireless-enabled television sets, or the like; and so forth. The wireless communication resources can include radio units (also referred to as radios) having circuitry for processing of wireless signals, processor(s), memory device(s), and the like, where the radio, the processor(s), and the memory device(s) can be coupled via a bus architecture.

The computing devices included in the example operational environment 100, as well as other computing devices contemplated in the present disclosure, can implement channel update of a sleepy-end device (SED), as described herein. It should be appreciated that other functional elements (e.g., servers, routers, gateways, and the like) can be included in the operational environment 100. It should be appreciated that the power-saving aspects of this disclosure can be implemented in any telecommunication environment including a wireline network (e.g., a cable network, an internet-protocol (IP) network, an industrial control network, any wide area network (WAN), a local area network (LAN), a personal area network (PAN), a home area network (HAN) (such as a sensor-based network) or the like); a wireless network (e.g., a cellular network (either small-cell network or macro-cell network), a wireless WAN (WWAN), a wireless LAN (WLAN), a wireless PAN (WPAN), a wireless HAN, such as a wireless sensor-based network, a satellite network, or the like); a combination thereof; or the like.

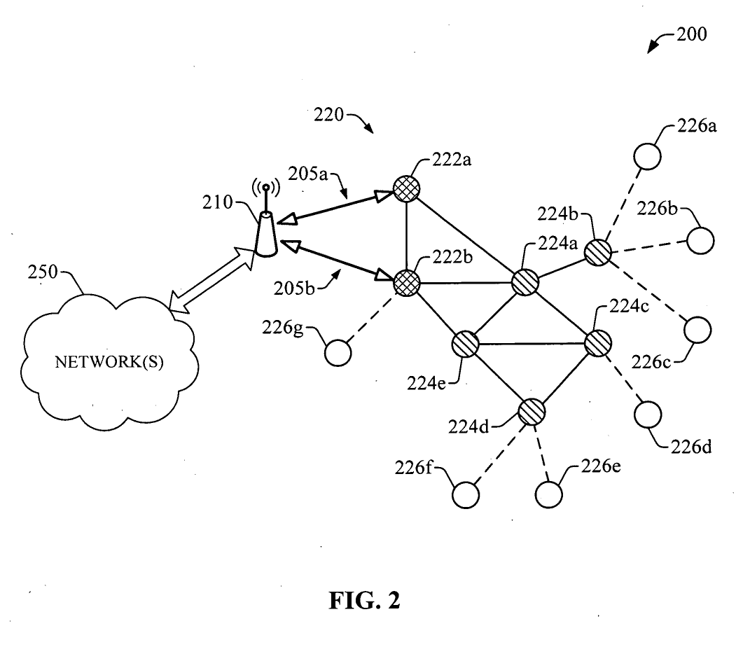

FIG. 2 illustrates an example of an operational environment 200 in accordance with one or more embodiments of the disclosure. The operational environment 200 includes a mesh network 220 having devices that can operate according to Thread protocols and/or any other communication protocols suitable for, among other things, IP-based communication (e.g., IPv6 protocol), low-power, secure, low-latency (e.g., less than about 100 ms) and/or scalable operation of the devices (e.g., smartphones, tablet computers, appliances, sensors, locks, and the like). The devices can include, in some embodiments; appliances; devices for access controls (e.g., locks); devices for climate control (e.g., temperature sensors, heaters, refrigeration devices, etc.); devices for energy management, lamps, light bulbs, or other type of devices for lightning; devices for safety (e.g., cameras) and or other types of security (e.g., alarms). Some of the devices can be powered via a conventional power grid, other devices can be powered via a combination between power grid and battery or other type of energy storage, and yet other devices can be powered via batteries or elements for energy harvesting. At least some of the devices included in the mesh network 220 also can communicate according to other protocols, such as Wi-Fi protocols, beyond Thread protocols or NAN protocols. In some implementations, the mesh network 220 is functionally coupled to an AP device 210 that permits functional coupling with one or more external networks 250 (such as the Internet or another type of WAN/WWAN). One or more devices within the mesh network 220 can permit functional coupling between the mesh network 220 and the AP device 210, each of the one or more devices can be referred to as border router device (or border router). In some embodiments, Wi-Fi wireless links can permit exchange of information between the AP device 220 and the one or more border routers. In other embodiments, other types of wireless links (e.g., femtocell wireless links) or wireline links (e.g., Ethernet links) can permit communication between the one or more border router devices and the AP device 210. As illustrated, in the operational environment 200, border routers 222a and 222b can be functionally coupled to AP device 201 via Wi-Fi links 205a and 205b, respectively. A border router can be functionally coupled to one or more devices within the mesh network 220, at least one of the devices coupled to the border router can be referred to as a router node (or router device or router). Other device(s) coupled to the border router can be a leaf node (e.g., a SED). Border routers provide services, such as routing services for off-network operations, for devices within the mesh network 220.

A router can provide routing services to devices within the mesh network 220. In addition or in the alternative, a router can provide joining services and/or security services for a device that attempts to join the mesh network 220. As opposed to SEDs, a router is not configured to enter a power-off mode or other type of low-power state. The exemplified operational environment includes five routers 224a-224d. In some embodiments, border routers and routers can exchange information according to Thread protocols. In one example, wireless links pertaining to a Thread WPAN (such as 6Lo links) can permit communication of network data and/or network signaling between such devices. Such links are represented as solid lines in FIG. 2.

In addition, a router (e.g., router 224b) can be coupled to one or more leaf nodes (or leaf devices) within the mesh network 220. In one implementation, a lead node can be referred to as a SED. A leaf node (or SED) can be embodied in or can include a host device, and can communicate via a parent router associated with the lead node. As such, the leaf node cannot forward messages to another lead node. The illustrated operational environment 200 includes seven leaf nodes 226a-226g. In some embodiments, wireless links pertaining to a Thread WPAN (such as 6Lo Sleepy links) can permit communication of network data and/or network signaling between a router and a leaf node. Such wireless links are represented with dashed lines in FIG. 2. A leaf node (or SED) can be powered via a battery or other type of energy storage and supply device. In addition or in some embodiments, a leaf node can be powered via a device that permits harvesting energy (e.g., a solar panel, a turbine, geothermal energy conversion devices, etc.). Leaf nodes can include one or more of thermostat, light switches, smoke detectors, carbon monoxide detectors, displays, door bells, intrusion sensors, automated cleaning devices, door sensors or other type of presence sensors, actuation sensors (e.g., window, door, etc.), motion sensors, door locks, radiator valves, biometric devices, fans, smart plugs, smart meters, appliances, HVAC equipment, a combination thereof, or the like.

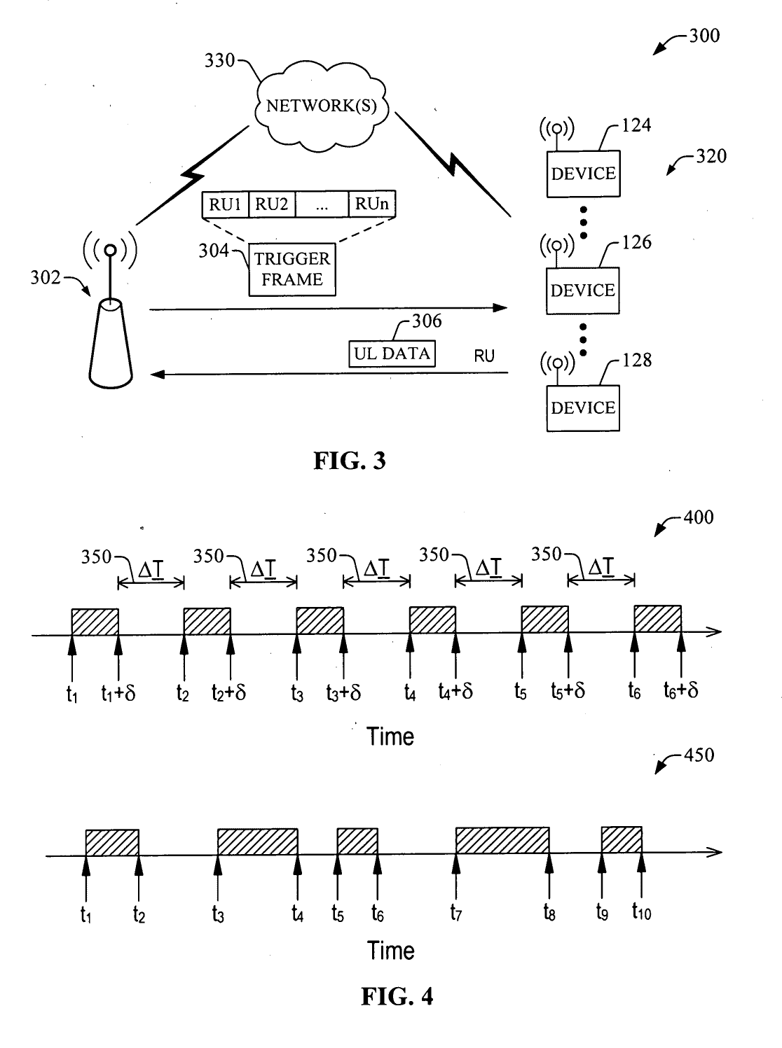

FIG. 3 presents another example of an example of an operational network 300 that can utilize or otherwise leverage power-saving architecture and/or techniques in accordance with one or more embodiments of the disclosure. The exemplified network environment 300 can allocate UL resources according to OFDMA, as described herein. As illustrated, the operational network 300 may include one or more AP devices 302 that communicate with one or more internet of things (IoT) devices 320, in accordance with IEEE 802.11 communication standards, including IEEE 802.11 ax. The one or more IoT devices 320 and the one or more AP devices 302 may be devices that are non-stationary, without fixed locations, or may be stationary, with fixed locations. The IoT device(s) 320 (e.g., device 124, device 126, or device 128) may include any suitable processor-driven IoT device, including a desktop device; a laptop device; a server device; a router device; a switch device; an access point device; a smartphone; a tablet computer; wearable wireless device (e.g., bracelet, watch, glasses, ring, etc.), sensors, cameras (e.g., which can operate in the visible and/or infrared); actuator devices (e.g., locks, valves, etc.); a combination of the foregoing; and so forth. As such, in one example, the IoT device(s) 320 can include one or more sensors for sensing and/or detecting pressure, temperature, motion, humidity, carbon monoxide, or smoke.

In at least some embodiments, the IoT device(s) 320 (e.g., device 124, device 126, and/or device 128) can be configured to communicate with each other and/or with another device via, for example, one or more networks 330 (e.g., a wireless network and/or a wireline network). Such communication can be performed wirelessly or otherwise. Thus, each (or, in some embodiments, at least one) of AP device(s) 302 may be wirelessly coupled to at least of the IoT device(s) 320, and each (or, in some embodiments, at least one) of the IoT device(s) 320 may be functionally coupled to an AP device of the access point devices 302 and/or an IoT device of the IoT device(s) 320.

In the operational environment 300, IoT device(s) 320, including at least one HEW IoT device, may communicate with each other and transmit data on a communication channel, such as a primary communication channel or a secondary communication channel. In some aspects, such IoT device(s) may randomly access the communication channel in order to transmit their respective data. In some situations, the IoT device(s) may access the communication channel using allocated (or scheduled) resource units (RUs). In the case of random access, in one embodiment, an access point device (e.g., one of AP device(s) 302) may send a random access trigger frame 304 indicating that resource units are available for random access. The random access resource units may be selected by at least one of the IoT device(s) (e.g., IoT devices 124, 126 and/or 128) to send data and/or receive other data. As shown, the resource units may be represented by RU1, RU2, . . . RUn, where n is a natural number. These resource units may be arranged in a sequence such that an IoT device of the IoT device(s) 320 may determine which resource unit was selected when the IoT device is ready to transmit data. In addition, these resource units may be resources in time domain, frequency domain or in a combination of time and frequency domain. The IoT device may utilize or otherwise leverage one of these resource units in order to send data to an access point device (e.g., one of the AP device(s) 302). Therefore, in one aspect, in response to detecting of the trigger frame 104, an IoT device of the IoT device(s) 320 may identify it as a random access trigger frame. Such identification can be permitted or otherwise facilitated by the access point device configuring an identifier in the trigger frame and/or by other information structures (such as an attribute) to characterize the trigger frame 304 as a random access trigger frame. The IoT device can then select a resource unit from the resource units referenced in the trigger frame 304 by which to transmit at least a portion of its data, e.g., UL data 306, to the access point device that transmitted the trigger frame 304. The resource unit can be selected in numerous ways.

The IoT device(s) 320 may be assigned one or more resource units or may randomly access a communication channel. It is understood that, in some scenarios, a resource unit can include bandwidth allocation on the communication channel in time domain and/or frequency domain. For example, with respect to an AP device that assigns resource units, in a channel of 20 MHz there may be a total of nine (9) resources units, each of the size of a basic resource unit of 26 tones. At least one of the AP device(s) 302 can assign one or more of such resource units to one or more IoT device(s) 320 to transmit their respective uplink data.

Any of the network(s) 330 may include any one of a combination of different types of suitable communications networks such as, for example, broadcasting networks, cable networks, public networks (e.g., the Internet), private networks, wireless networks, cellular networks, or any other suitable private and/or public networks. Further, any of the communications networks 330 can have any suitable communication range associated therewith, and can include, for example, global network's (e.g., the Internet), metropolitan area networks (MANs), WANs, LANs, or PANs. In addition, any of the communications networks 130 can include any type of medium over which network traffic may be carried including, but not limited to, coaxial cable, twisted-pair wire, optical fiber, a hybrid fiber coaxial (HFC) medium, microwave terrestrial transceivers, radio frequency communication mediums, white space communication mediums, ultra-high frequency communication mediums, satellite communication mediums, or any combination thereof.

Any of the IoT device(s) 320 (e.g., IoT devices 124, 126, or 128), and AP device(s) 302 can include one or more communication antennas. A communication antenna can be embodied in or can include any suitable type of antenna corresponding to the communications protocols used by the IoT device(s) 120 and the AP device 102. Examples of suitable communications antennas can include Wi-Fi antennas, IEEE 802.11 family of standards compatible antennas, directional antennas, non-directional antennas, dipole antennas, folded dipole antennas, patch antennas, multiple-input multiple-output (MIMO) antennas, or the like. A communication antenna can be functionally coupled (e.g., communicatively coupled) to a radio unit to transmit and/or receive signals, such as communications signals to and/or from the IoT device(s) 320.

Any of the IoT device(s) 320 and AP device(s) 302 may include any suitable radio and/or transceiver for transmitting and/or receiving radio frequency (RF) signals in the bandwidth and/or channels corresponding to the communications protocols utilized by any of the IoT device(s) 320 and AP device(s) 302 to communicate with each other. The radio components may include hardware and/or software to modulate and/or demodulate communications signals according to pre-established transmission protocols. The radio components may further have hardware and/or software instructions to communicate via one or more Wi-Fi and/or Wi-Fi direct protocols, as standardized by the Institute of Electrical and Electronics Engineers (IEEE) 802.11 standards. In certain example embodiments, the radio component, in cooperation with the communications antennas, may be configured to communicate via 2.4 GHz channels (e.g. 802.11b, 802.11g, 802.11n), 5 GHz channels (e.g. 802.11n, 802.11 ac), or 60 GHZ channels (e.g. 802.11 ad). In some embodiments, non-Wi-Fi protocols may be used for communications between devices, such as Bluetooth, dedicated short-range communication (DSRC), Ultra-High Frequency (UHF) (e.g. IEEE 802.11af, IEEE 802.22), white band frequency (e.g., white spaces), or other packetized radio communications. The radio component may include any known receiver and baseband suitable for communicating via the communications protocols. The radio component may further include a low noise amplifier (LNA), additional signal amplifiers, an analog-to-digital (A/D) converter, one or more buffers, and digital baseband.

In accordance with some aspects of this disclosure, at least one (or, in some embodiments, each) of the IoT device(s) 320 and at least one (or, in some embodiments, each) of the AP device(s) 302 can have wakeup times and respective wakeup durations during which operation is performed with the device fully energized. At other times between wakeup times, the device can operate in power-save mode (which also may be referred to as “sleep” mode). Accordingly, during power-save mode, only some functionality may be operational in the device, and thus, power can be saved during such periods. Similarly, during wakeup periods the device can be fully operational or otherwise available for operation as intended (e.g., sensing, illumination, security, communication, a combination thereof, or the like). Therefore, in at least some embodiments, a defined schedule of wakeup times and respective durations can be referred to as an availability schedule. In some implementations, as illustrated in diagram 400 of FIG. 4, an availability schedule can be periodic, having wakeup periods (shown as hashed blocks) periodically occurring with a defined period ΔT (a real number which can be expressed in units of time). In other implementations, as illustrated in diagram 450 in FIG. 4, wakeup periods can be non-periodic, forming, in some instances, a pattern beyond regularly interleaved wakeup periods. Times and/or durations associated with wakeup periods and power-save periods can have different time scales. Specifically, in one example, an availability schedule can correspond to a long-term schedule of repeating intervals of availability spanning multiple beacon intervals—e.g., several seconds to minutes or hours, where a beacon interval have a defined duration, such as approximately 100 ms, for example. In addition or in another example, the availability schedule can correspond to a short-term schedule of repeating intervals of availability spanning a single beacon interval.

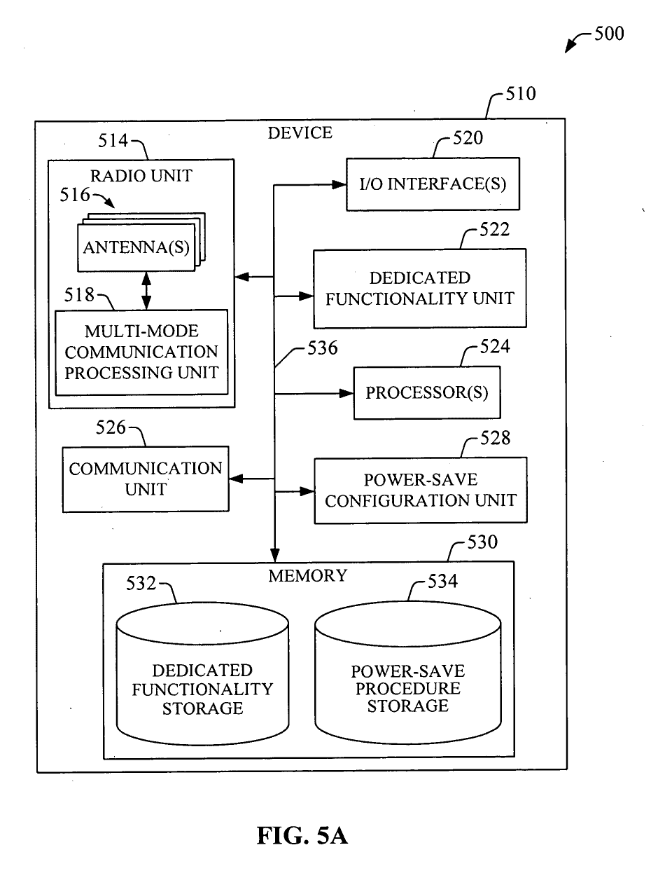

FIG. 5A illustrates a block diagram of an example embodiment of a device 510 in accordance with one or more embodiments of the disclosure. The exemplified device 510 can operate in accordance with at least some aspects of the disclosure, implementing power-saving operations as described herein, for example. As mentioned, in some embodiments, the device 510 can embody or can constitute any one of devices in the operational environment 100. Similarly, in other embodiments, the device 510 can embody or can constitute a device in a low-power mesh network, such as the example mesh network 220 in FIG. 2. As such, the device 510 can embody a border router device, a router device, a leader device, or a SED. In yet other embodiments, the device 510 can embody or can constitute an AP device of the AP device(s) 302 or an IoT device of the IoT device(s) 320 in the operational environment 300. As such, in some aspects, the device 510 can provide one or more specific functionalities—such as operating as a digital camera and generating digital images (e.g., static pictures and/or motion pictures); operating as a navigation device; operating as a biometric device (e.g., a heart rate monitor, a pressure monitor, a glucometer, an iris analyzer, a fingerprint analyzer, etc.); dosing and delivering an amount of a drug or other compound; operating as a sensor and sensing a defined physical quantity, such as temperature and/or pressure, or motion; operating as another sensor and sensing a compound in gas phase or liquid phase; operating as a controller for configuring a second defined physical quantity, managing energy, managing access to an environment, managing illumination and/or sound, regulating a defined process, such an automation control process, or the like; generating current, voltage, or other type of signal via inductive coils; a combination of the foregoing; a derivative functionality of the foregoing; or the like. To that end, the device 510 can include one or more functionality units 522 (referred to as dedicated functionality unit 522) that can include optical elements (e.g., lenses, collimators, light guides, light sources, light detectors (such as semiconductor light detectors), focusing circuitry, etc.); temperature sensors; pressure sensors; gas sensors; motion sensors, including inertial sensors (such as linear accelerator and/or a gyroscope); mechanical actuators (such as locks, valves, and the like); a combination of the foregoing; or the like.

In addition or in other aspects, a specific functionality of the device 510 can be provided or otherwise implemented via one or more processors 524. In some implementations, at least one of the processor(s) 524 can be integrated with dedicated functionality unit 522. In some implementations, at least one of the processor(s) (e.g., one or more of the processor(s) 524 or other processor(s)) can receive and operate on data and/or other type of information (e.g., analog signals) generated by components of the dedicated functionality unit 522. The at least one processor can execute a module in order to operate on the data and/or other type of information and, as a result, provide a defined functionality. The module can be embodied in or can include, for example, a software application stored in a memory device integrated into or functionally coupled to the device. For instance, the module can be retained in one or more memory devices 532 (collectively referred to as dedicated functionality storage 532), where the dedicated functionality storage 532 can be retained within one or more other memory devices 530 (collectively referred to as device 530). In addition or in other implementations, at least a second one of the processor(s) (e.g., one or more of processor(s) 524 or other processor(s) available to the dedicated functionality unit 522) can control the operation or duty cycle of a portion of the dedicated functionality unit 522 so as to collect data and/or other type of information; provide an amount (or a dose) of a compound or acquire another amount of another compound or material; a combination of the foregoing; or the like. At least one of the units that constitute the dedicated functionality unit 522 can generate control signals (e.g., interruptions, alarms, or the like) and/or can cause the device 510 to transition between operational states in response to a defined condition of the device 510 or its environment. At least some of the control signals can be sent to an external device (not depicted in FIG. 5A) via an I/O interface of the I/O interfaces 520. The type and/or number of components included in the dedicated functionality unit 522 can establish, at least in part, the complexity of the device 510. In some examples, the device 510 can embody or can constitute an AP device, and in other examples, the device 510 can embody or can constitute a SED or another type of IoT device.

The device 510 also can operate as a wireless communication device, communicating wirelessly in accordance with aspects of this disclosure. As such, the device 510 can embody or can constitute an AP device, a mobile computing device (e.g., a station device or user equipment), or other types of communication devices that can transmit and/or receive wireless communications in accordance with this disclosure. In some aspects, to permit wireless operation—including the exchange of information associated with configuration of a data path group, as described herein—the device 510 includes a radio unit 514, a communication unit 526, and a power-save configuration unit 528. In some implementations, the communication unit 526 can generate packets and/or other types of information blocks via a network stack, for example, and can convey the packets and/or the other types of information blocks to the radio unit 514 for wireless communication. In one embodiment, the network stack (not shown) can be embodied in or can constitute a library or other types of programming modules, and the communication unit 526 can execute the network stack in order to generate a packet or other types of information block. Generation of the packet or the other types of information blocks can include, for example, generation of control information (e.g., checksum data, communication address(es)), traffic information (e.g., payload data), and/or formatting of such information into a specific packet header.

The power-save configuration unit 528 can perform or otherwise facilitate, at least in part, the power-saving techniques or other types of operations to conserve power in accordance with aspects of this disclosure. To that end, in some embodiments, the power-save configuration unit 528 can include a number of components that can utilize or otherwise leverage information (e.g., data, metadata, and/or instructions) defining or otherwise specifying implementations of one or more mechanisms for conserving power available to the device 510 in accordance with aspects of the disclosure. In some instances, such information can be retained in one or more memory elements 534 (collectively referred to as power-save procedure storage 534) within the memory 530. In addition or in other instances, the first information and/or the second information can be retained within one or more other memory devices integrated into the power-save configuration unit 528. The power-save configuration unit 528 also can utilize or otherwise leverage, in other embodiments, the communication unit 526 in order to configure a data path group in accordance with aspects of this disclosure, as described herein.

As illustrated in FIG. 5A, the radio unit 514 can include one or more antennas 516 and a multi-mode communication processing unit 518. In some embodiments, the antenna(s) 516 can be embodied in or can include directional or omnidirectional antennas, including, for example, dipole antennas, monopole antennas, patch antennas, loop antennas, microstrip antennas or other types of antennas suitable for transmission of RF signals. In addition, or in other embodiments, at least some of the antenna(s) 516 can be physically separated to leverage spatial diversity and related different channel characteristics associated with such diversity. Further or in yet other embodiments, the multi-mode communication processing unit 518 that can process at least wireless signals in accordance with one or more radio technology protocols and/or modes (such as multiple-input multiple-output (MIMO), single-input-multiple-output (SIMO), multiple-input-single-output (MISO), and the like). Each of such protocol(s) can be configured to communicate (e.g., transmit, receive, or exchange) data, metadata, and/or signaling over a specific air interface. The one or more radio technology protocols can include, for example, 3GPP UMTS; LTE; LTE-A; Wi-Fi protocols, such as those of the Institute of Electrical and Electronics Engineers (IEEE) 802.11 family of standards; Worldwide Interoperability for Microwave Access (WiMAX); radio technologies and related protocols for ad hoc networks, such as Bluetooth® or ZigBee®; other protocols for packetized wireless communication; or the like). The multi-mode communication processing unit 418 also can process non-wireless signals (analogic, digital, a combination thereof, or the like).

In some embodiments, e.g., example embodiment 550 shown in FIG. 5B, the multi-mode communication processing unit 518 can comprise a set of one or more transmitters/receivers 554, and components therein (amplifiers, filters, analog-to-digital (A/D) converters, etc.), functionally coupled to a multiplexer/demultiplexer (mux/demux) unit 568, a modulator/demodulator (mod/demod) unit 566 (also referred to as modem 516), and a coder/decoder unit 512 (also referred to as codec 512). Each (or, in some instances, at least one) of the transmitter(s)/receiver(s) can form respective transceiver(s) that can transmit and receive wireless signal (e.g., electromagnetic radiation) via the one or more antennas 516. It is noted that in other embodiments, the multi-mode communication processing unit 518 can include, for example, other functional elements, such as one or more control units (e.g., a memory controller), an offload engine or unit, I/O interfaces, baseband processing circuitry, a combination of the foregoing, or the like. While illustrated as separate blocks in the device 510, it is noted that in some embodiments, at least a portion of the multi-mode communication processing unit 518, the communication unit 526, and/or data-path-group configuration unit can be integrated into a single unit—e.g., a single chipset or other type of solid state circuitry. In some aspects, such a single unit can be configured by programmed instructions retained in memory 530 and/or other memory devices integrated into or otherwise functionally coupled to the single unit.

Electronic components and associated circuitry, such as mux/demux unit 558, codec 562, and modem 566 can permit or otherwise facilitate processing and manipulation, e.g., coding/decoding, deciphering, and/or modulation/demodulation, of signal(s) received by the device 510 and signal(s) to be transmitted by the device 510. In some aspects, as described herein, received and transmitted wireless signals can be modulated and/or coded, or otherwise processed, in accordance with one or more radio technology protocols. Such radio technology protocol(s) can include, for example, 3GPP UMTS; 3GPP LTE; LTE-A; Wi-Fi protocols, such as IEEE 802.11 family of standards (IEEE 802.ac, IEEE 802.ax, and the like); IEEE 802.15.4; WiMAX; radio technologies and related protocols for ad hoc networks, such as Bluetooth® or ZigBee®; other protocols for packetized wireless communication; or the like.

The electronic components in the multi-mode communication processing unit 518, including the one or more transmitters/receivers 554, can exchange information (e.g., data, metadata, code instructions, signaling and related payload data, combinations thereof, or the like) through a bus 564, which can embody or can include at least one of a system bus, an address bus, a data bus, a message bus, a reference link or interface, a combination of the foregoing, or the like. Each (or, in some embodiments, at least one) of the one or more receivers/transmitters 554 can convert signal from analog to digital and vice versa. In addition or in the alternative, the receiver(s)/transmitter(s) 554 can divide a single data stream into multiple parallel data streams, or perform the reciprocal operation. Such operations may be conducted as part of various multiplexing schemes. As illustrated, the mux/demux unit 558 is functionally coupled to the one or more receivers/transmitters 554 and can permit processing of signals in time and frequency domain. In some aspects, the mux/demux unit 558 can multiplex and demultiplex information (e.g., data, metadata, and/or signaling) according to various multiplexing schemes such as time division multiplexing (TDM), frequency division multiplexing (FDM), orthogonal frequency division multiplexing (OFDM), code division multiplexing (CDM), space division multiplexing (SDM). In addition or in the alternative, in another aspect, the mux/demux unit 558 can scramble and spread information (e.g., codes) according to most any code, such as Hadamard-Walsh codes, Baker codes, Kasami codes, polyphase codes, and the like. The modem 566 can modulate and demodulate information (e.g., data, metadata, signaling, or a combination thereof) according to various modulation techniques, such as frequency modulation (e.g., frequency-shift keying), amplitude modulation (e.g., M-ary quadrature amplitude modulation (QAM), with M a positive integer; amplitude-shift keying (ASK)), phase-shift keying (PSK), and the like). In addition, processor(s) that can be included in the device 510—e.g., processor(s) 524, or baseband processing circuitry or other type of computing circuitry included in the radio unit 514 or other functional element(s) of the device 510—can permit processing data (e.g., symbols, bits, or chips) for multiplexing/demultiplexing, modulation/demodulation (such as implementing direct and inverse fast Fourier transforms) selection of modulation rates, selection of data packet formats, inter-packet times, and the like.

The codec 562 can operate on information (e.g., data, metadata, signaling, or a combination thereof) in accordance with one or more coding/decoding schemes suitable for communication, at least in part, through the one or more transceivers formed from respective transmitter(s)/receiver(s) 554. In one aspect, such coding/decoding schemes, or related procedure(s), can be retained as computer-accessible instructions (computer-readable instructions, computer-executable instructions, or a combination thereof) in the memory 530 and/or other memory device integrated into or otherwise functionally coupled to the radio unit 514. In a scenario in which wireless communication among the device 510 and another computing device (e.g., a station device, other types of user equipment, or customer premises equipment) utilizes MIMO, MISO, SIMO, or SISO operation, the codec 562 can implement at least one of space-time block coding (STBC) and associated decoding, or space-frequency block (SFBC) coding and associated decoding. In addition or in other scenarios, the codec 562 can extract information from data streams coded in accordance with spatial multiplexing scheme. In some aspects, to decode received information (e.g., data, metadata, signaling, or a combination thereof), the codec 562 can implement at least one of computation of log-likelihood ratios (LLR) associated with constellation realization for a specific demodulation; maximal ratio combining (MRC) filtering, maximum-likelihood (ML) detection, successive interference cancellation (SIC) detection, zero forcing (ZF) and minimum mean square error estimation (MMSE) detection, or the like. The codec 562 can utilize, at least in part, mux/demux unit 558 and mod/demod unit 566 to operate in accordance with aspects described herein.

With further reference to FIG. 5A, the device 510 can operate in a variety of wireless environments having wireless signals conveyed in different electromagnetic radiation (EM) frequency bands. To at least such end, the multi-mode communication processing unit 518 in accordance with aspects of the disclosure can process (code, decode, format, etc.) wireless signals within a set of one or more EM frequency bands (also referred to as frequency bands) comprising one or more of radio frequency (RF) portions of the EM spectrum, microwave portion(s) of the EM spectrum, or infrared (IR) portion(s) of the EM spectrum. In one aspect, the set of one or more frequency bands can include, for example, at least one of (i) all or most licensed EM frequency bands, (such as the industrial, scientific, and medical (ISM) bands, including the 2.4 GHz band or the 5 GHz bands); or (ii) all or most unlicensed frequency bands (such as the 60 GHz band) currently available for telecommunication.

As described herein, the device 510 can receive and/or transmit information encoded and/or modulated or otherwise processed in accordance with aspects of the present disclosure. To at least such an end, in some embodiments, the device 510 can acquire or otherwise access information wirelessly via the radio unit 514 (which also may be referred to as radio 514), where at least a portion of such information can be encoded and/or modulated in accordance with aspects described herein. Therefore, in some implementations, the memory 530 also can contain one or more memory elements having information suitable for processing information received according to a predetermined communication protocol (e.g., IEEE 802.11 ac, IEEE 802.11ax, IEEE 802.15.4). While not shown, in some embodiments, one or more memory elements (e.g., registers, filed, databases, combinations thereof, or the like) of the memory 534 can include, for example, computer-accessible instructions that can be executed by one or more of the functional elements (units, components, circuitry, etc.) of the device 510 in order to implement at least some of the functionality for configuration of data path groups in a wireless network, in accordance with aspects described herein. One or more groups of such computer-accessible instructions can embody or can constitute a programming interface that can permit communication of information (e.g., data, metadata, and/or signaling) between functional elements of the device 510 for implementation of such functionality.

As further illustrated in FIG. 5A, the device 510 can include one or more I/O interfaces 520. At least one of the I/O interface(s) 520 can permit the exchange of information between the device 510 and another computing device and/or a storage device. Such an exchange can be wireless (e.g., via near field communication or optically-switched communication) or wireline. At least another one of the I/O interface(s) 520 can permit presenting information visually, aurally, and/or via movement to an end-user of the device 510. In one example, a haptic device can embody the I/O interface of the I/O interface(s) 520 that permit conveying information via movement. In addition, in the illustrated device 510, a bus architecture 536 (which also may be referred to as bus 536) can permit the exchange of information (e.g., data, metadata, and/or signaling) between two or more functional elements of the device 510. For instance, the bus 536 can permit exchange of information between two or more of (i) the radio unit 514 or a functional element therein, (ii) at least one of the I/O interface(s) 520, (iii) the communication unit 526, or (iv) the memory 530 and elements therein. In addition, one or more application programming interfaces (APIs) (not depicted in FIG. 5A) or other types of programming interfaces that can permit exchange of information (e.g., data and/or metadata) between two or more of the functional elements of the device 510. At least one of such API(s) can be retained or otherwise stored in the memory 530. In some embodiments, it is noted that at least one of the API(s) or other programming interfaces can permit the exchange of information within components of the communication unit 526. The bus 536 also can permit a similar exchange of information. In some embodiments, the bus 536 can embody or can include, for example, at least one of a system bus, an address bus, a data bus, a message bus, a reference link or interface, a combination thereof, or the like. In addition or in other embodiments, the bus 552 can include, for example, components for wireline and wireless communication.

It is noted that portions of the device 510 can embody or can constitute an apparatus. For instance, the multi-mode communication processing unit 518, the communication unit 526, the power-save configuration unit 528, and at least a portion of the memory 434 can embody or can constitute an apparatus that can operate in accordance with one or more aspects of this disclosure.

According to some embodiments, availability intervals of an AP device may be configured based at least on two aspects: (i) the AP device may be in power save mode and (ii) STAs can operate in 2 MHz receive and transmit mode. Therefore, STAs might not be able to decode 20 MHz beacons transmitted at regular intervals of 100 ms. These STAs might rely on specific wake-up times and initiation of such wake-up times may be signaled by the AP device by using a defined or otherwise dedicated synchronization frame transmitted in a dedicated 2 MHz channel. In some implementations, the AP device can be embodied in or can include the example device 510 shown in FIG. 5A, where the power-save configuration unit 528 and/or the communication unit 526 can provide, e.g., generate and send, such synchronization frames. In addition or according to other embodiments can include a short and long term target wake times (TWTs) and durations, for example, schedules of availability patterns, for synchronization in point-to-point (P2P) and point-to-multipoint WLAN access networks.

Devices, apparatuses, systems, and/or other architectures in accordance with aspects of the disclosure can perform or can facilitate operations for power conservation as described herein. Such operations can embody or can constitute power-saving techniques that can be implemented in AP devices, STAs, CPE, or any other type of devices that may have limited or otherwise constrained access to power or energy. As described herein, such techniques may include, in one example, broadcasting schedules of availability patterns, for example, short term and long term multi TWT start times and durations, by an AP device to all STAs (e.g., all of the IoT devices 320), a group of STAs (e.g., a subset of the IoT devices 320), or a single STA. In addition or in another example, the techniques can include one or more of negotiating between AP device and STA or STA and STA in case of peer-to-peerP2P; defining mutual short term and long term multi schedules availability patterns; signaling between AP device and STA or, in case of P2P, STA and STA request(s) to modify the schedules availability patterns, synchronization of schedules of availability patterns between AP and STA via dedicated management signaling in narrow bandwidths.

In one example embodiment, an AP device can broadcast short and long term TWTs and durations of availability to all STAs, group of STAs, or a single STA. To at least that end, in one example, the AP device can be embodied in or can include the device 510 shown in FIG. 5, where the power-save configuration unit 528 can configure one or more of the short term TWTs and associated durations or the long term TWTs and associated durations. In addition, the power-save configuration unit 528 can retain a set of defined TWTs and respective durations in a power-save procedure storage 534. In such an example, the AP device also can include a communication unit 526 that can send, via a radio unit 514, a frame including information representative of TWT(s) and/or associated durations. In one example embodiment, the access gateway device or sensor hub device has a defined schedule of wakeup time and/or sleep times that can be published within a broadcast frame, for example, in all beacons or dedicated beacons, probe responses, etc. or per request of a specific STA in a unicast frame. These frames may be transmitted in narrow band to cater to STAs operating in narrow bands only. Such a schedule can be retained in one or more memory devices integrated into or otherwise functionally coupled to the access gateway device or sensor hub.

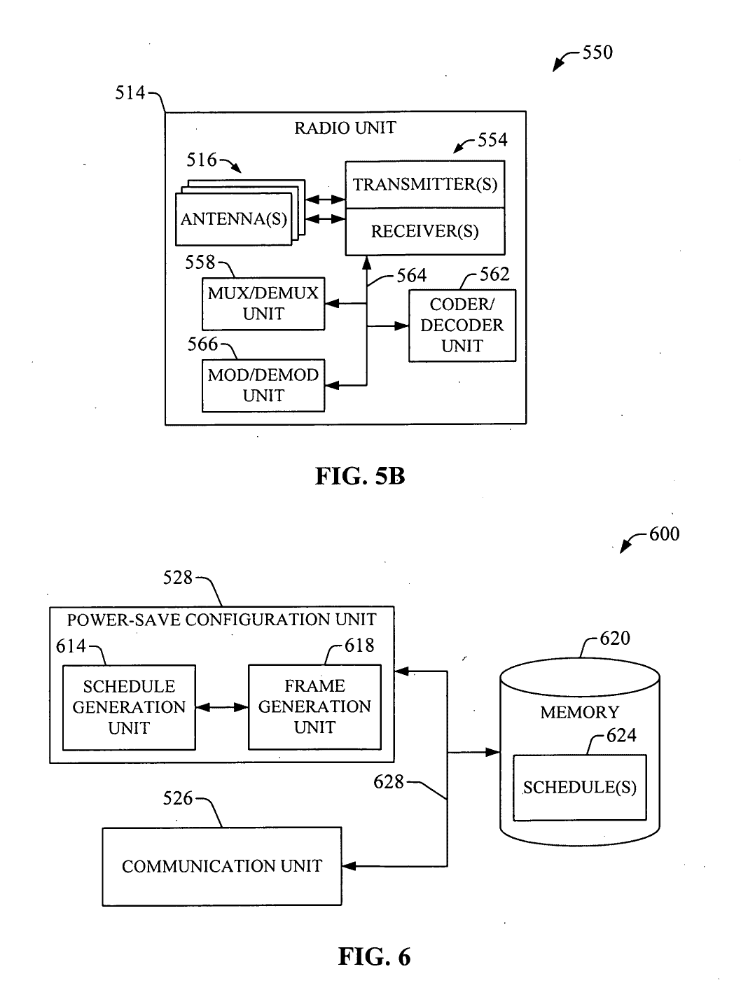

FIG. 6 presents an example of an apparatus 600 that can implement power-saving operations in accordance with one or more embodiments of the disclosure. A device can include the apparatus 600, and can embody an AP device, for example. In some aspects, the apparatus can advertise or can permit the device to advertise a defined availability schedule to a remote device that can be functionally coupled (e.g., communicatively coupled) to the device. As illustrated in FIG. 6, the apparatus 600 can include a power-saving configuration unit 528 that can access an availability schedule comprising wakeup periods and power-save periods. The availability schedule can be retained one or more memory devices 620 (collective referred to as memory 620), within one or more memory elements 624 (collective referred to as schedule(s) 624). Thus, the schedule(s) can include information indicative of the availability schedule. In addition, the power-save configuration unit 528 can include a schedule generation unit 614 that can configure or otherwise compose the availability schedule, and can provide it to a device that includes the apparatus 600.

In addition, regardless of the manner in which an availability schedule is generated and/or access, the apparatus 600 can include a frame generation unit 618 that can configure a frame comprising information indicative of the availability schedule. Further, the frame generation unit 618 can signal the formation and/or availability of such a frame to a communication unit 526. In response, the communication unit 526 can direct the device that contains the apparatus 600 to send the frame to at least one second device. To that end, the device can include a radio unit, such as the radio unit 514. In some aspects, as described herein, the at least one second device can include a group of devices, each associated to the device (e.g., functionally coupled to the device). The apparatus 600, via the communication unit 526, for example, can direct the device to broadcast the frame in a narrowband portion of a communication channel to the group of devices. Further or in other aspects, the at least one second device can include a group of devices, each associated to the device. The apparatus 600, via the communication unit 526, for example, can direct the device to multicast the frame in a narrowband portion of a communication channel to a subset of the group of devices. Furthermore or in yet other aspects, the apparatus 600, via the communication unit 526, for example, can direct the device to send a unicast frame in a narrowband portion of a communication channel to a defined second device of the at least one second device. As mentioned, the frame that can send by the device can be embodied in or can include any management frame, such as an Authentication Response, an Association Response, a Channel Switch, and so forth.

As illustrated in FIG. 6, a bus architecture 628 (also termed bus 628) can functionally couples (e.g., electrically couple, mechanically coupled, and/or communicatively couple) some or all of functional elements (units, memory devices, etc.) of the example apparatus 600. The structure of the bus 628 can be or can constitute, in at least some embodiments, the structure of the bus 536 and/or bus 564 described herein.

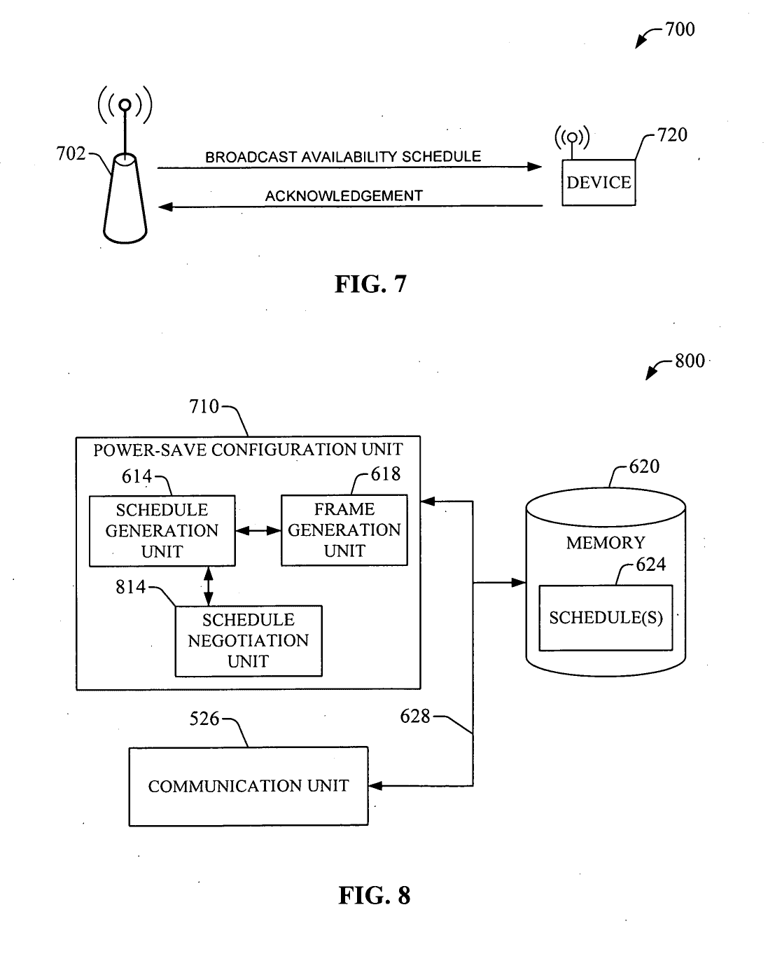

FIG. 7 illustrates an example of an operational environment 700 in which devices can perform or facilitate power-saving operations in accordance with aspects of the disclosure. The exemplified operational environment 700 includes an access point device 702 and a device 720 (e.g., an IoT device) that may be wirelessly coupled (e.g., communicatively coupled, inductively coupled, or the like) to the access point device 702. It is noted that the device 720 can be wirelessly coupled to one or more other devices (e.g., IoT devices; not depicted in FIG. 6). According to this example embodiment, the access point device 702 can send (e.g., broadcast) an availability schedule 710 of the AP device 702 to the device 720, which may include sleep times and wake-up times and durations for the AP device 702. In response, the device 720 may transmit an acknowledgement or other type of signaling indicative or otherwise representative of reception of the availability schedule. It is noted that the device 720 also can have an apparatus with similar or identical functionality to that of the apparatus 600. Such functionality can include, for example, sending a response (acknowledgement signaling, an availability response, etc.) to reception of an availability schedule.

The wakeup time of the access gateway device (or, in some embodiments, the wakeup time of a STA) may be synchronized with the TWTs of associated sensors in the IoT network. This information may indicate short term and long term multi TWT/trigger frame start times and durations. To at least such ends, the access gateway device can include an apparatus, such as the apparatus 800 depicted in FIG. 8. Specifically, in some aspects, the apparatus 800 can include a power-save configuration unit 710 that can direct, via the communication unit 526, the access gateway device to send an availability schedule. As described herein, the availability schedule can include a long-term availability schedule, and to direct the access gateway device to send the availability schedule, the power-save configuration unit 710 can direct the access gateway device to send a narrowband broadcast frame within a narrowband portion of a communication channel, the broadcast frame comprising information indicative of the long-term availability schedule. In addition or in the alternative, the availability schedule can include a short-term availability schedule, and to direct the access gateway device to send the availability schedule, the power-save configuration unit 710 can direct the access gateway device to send a broadcast frame comprising information indicative of the short-term availability schedule.

In addition, the apparatus 800 can receive a second availability schedule of a second device in response to the availability schedule. For example, the access gateway device can include a radio unit 514, that can receive information wirelessly, where the information is indicative or otherwise representative of the second availability schedule. As described herein, it is noted that the second device also can have an apparatus with similar or identical functionality to that of the apparatus 800. Such functionality can include, for example, sending a response (acknowledgement signaling, an availability response, etc.) to reception of an availability schedule. The apparatus 800 can determine that the second availability schedule is different from the first availability schedule, and in response can negotiate a mutual availability schedule with the second device. To that end, the power-save configuration unit 810 can include a schedule negotiation unit 814 than can determine differences between the availability schedule and the second availability schedule. In response to ascertaining that a difference is present amongst such schedules, the schedule negotiation unit 814 can configure a new availability schedule having common (or otherwise synchronized) TWTs and respective durations, for example.

In some implementations, to negotiate a mutual availability schedule, the schedule negotiation unit 814 can modify a current availability schedule, e.g., the availability schedule transmitted from an AP device, to match a second availability schedule received from another device (e.g., an IoT device). In addition, the negotiation unit 814 can assign a modified availability scheduled to the mutual availability schedule. Further or in other implementations, to negotiate the mutual availability schedule, the schedule negotiation unit 814 can direct or otherwise cause, via the communication unit 526, for example, a device to send a request to modify the second availability schedule to a second device having such schedule.

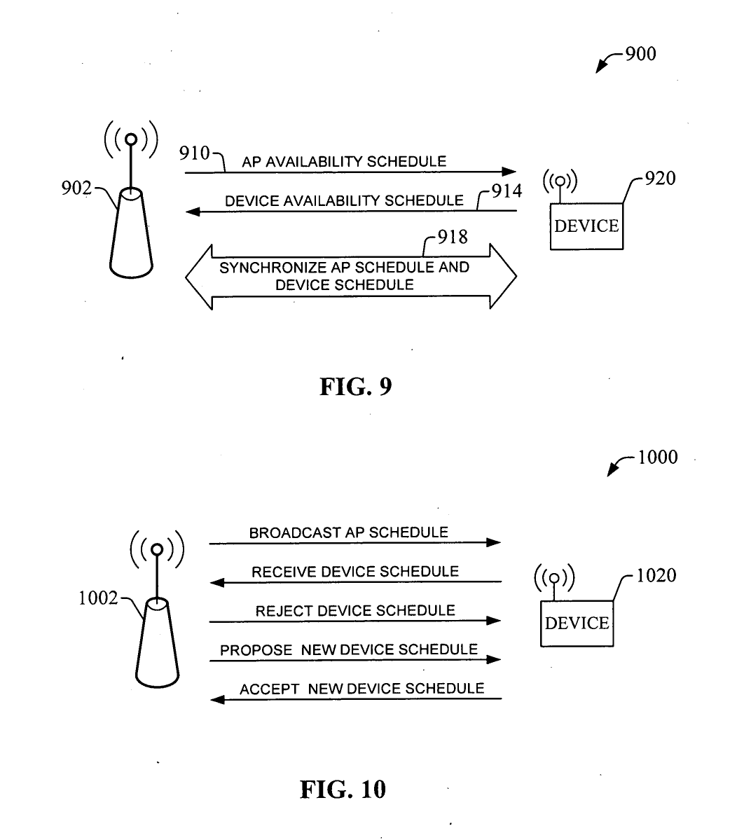

FIG. 9 illustrates another example of an operational environment 900 that can perform or facilitate power-saving operations in accordance with one or more embodiments of the disclosure. The exemplified operational environment 900 includes an access point device 902 and a device 920 (e.g., an IoT device or another AP device) that may be wirelessly coupled (e.g., communicatively coupled, inductively coupled, or the like) to the access point device 902. It is noted that the device 920 can be wirelessly coupled to one or more other devices (e.g., IoT device; not depicted in FIG. 9). According to this example embodiment, the access point device 902 can send an availability schedule 910 of the access point device 902 to the device 920, which may include sleep times and wake-up times and durations for the access point 902. In response, the device 920 may transmit to the AP their availability schedules 914, which may include sleep times and wake-up times and durations for the devices 920. According to this embodiment, the access point 902 and the device 920 can synchronize the availability schedule of the AP device 902 and a second availability schedule of the device 920.

The schedule negotiation unit 814 also can provide other functionality for determination of a mutual (or negotiated) availability schedule between two devices (e.g., an AP device and an IoT device). FIG. 10 presents an example of an operational environment 1000 in which devices can perform power-saving operations in accordance with one or more embodiments of the disclosure. More specifically, yet not exclusively, the power-saving operations in the operational environment 1000 can include negotiating a mutual schedule in multiple actions. As illustrated in FIG. 10, an access point device 1002 can be wirelessly coupled (e.g., communicatively coupled, inductively coupled, or the like) to a device 1020. It is noted that the device 720 can be wirelessly coupled to one or more other devices (e.g., IoT devices and/or another AP device; not depicted in FIG. 10). In some aspects, the AP device 1002 may broadcast or otherwise send the AP availability schedule to the device 1020 (and, in some embodiments, to other devices). As described herein, the AP availability schedule can include sleep times and/or wake-up times and respective durations of a power-on or otherwise energized period for the AP device 1002. In response, the device 1020 may send to the AP device 1002 a device availability schedule, which also can include sleep times and/or wakeup times and respective durations for the IoT device 1020. In some instances, the AP device 1002 can reject the device availability schedule, and also can propose a new device availability schedule. The new device availability schedule can be determined according to numerous factors, including historical information associated with power consumption or other types of operational characteristics of the device 1020 (e.g., available computing resources, type of energy storage devices that supply power, etc.). In a scenario in which the new device availability schedule is acceptable to the device 1020, then the new availability schedule can replace or otherwise can supplement current availability schedules of the access points 1020 and the device 1020.

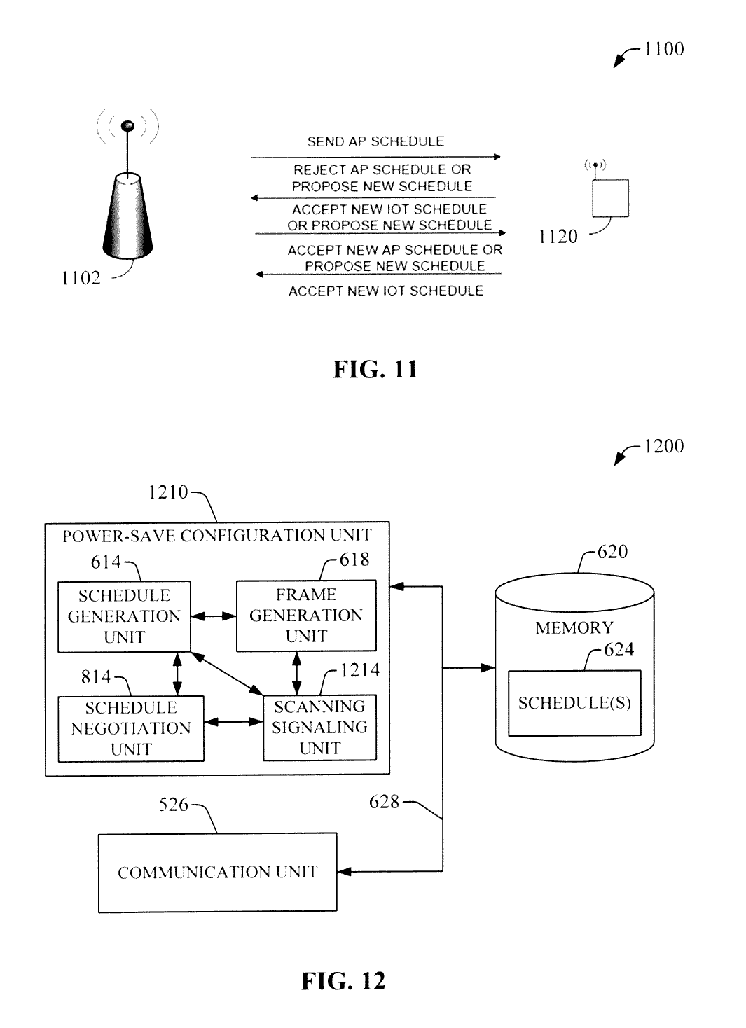

In another example embodiment as illustrated in FIG. 11, system 700 may include one or more access points 402 and one or more IoT devices 420 that may be wirelessly connected to the one or more access points 402 and to other devices 420. According to this example embodiment, access point 402 may broadcast or send the AP availability schedule to the one or more devices 420, which may include sleep times and wake-up times and durations for the access points 402. In response, the devices 420 may reject the AP availability schedule and propose a new availability schedule to the access point. The access point, in response, may accept the new IoT availability schedule or propose a new availability schedule. The IoT device may, in response, accept the new AP availability schedule or propose a further new IoT availability schedule. The access point at that point may accept the new IoT schedule.

According to one example embodiment, an AP device can have pre-defined different schedule patterns of various Trigger frame transmission types, for example for scheduled data and random access. In one example, the AP device can include one or more memory devices (such as the power-save procedure storage 534 or the memory 620) that can retain such schedule patterns. In order to enable multi long-term and short-term schedules availability patterns, in one example embodiment an AP device can indicate the long-term schedules availability or unavailability patterns of sleep intervals in spatial or narrow band broadcast frames, and short-term sleep intervals on other broadcast frames. As an illustration, the AP device can advertise long term intervals using DTIM beacons and short-term sleep intervals in TIM beacons for STAs that may decode wider band signals. In some aspects, an STA wake-up time, also termed as the STA service availability, can be the time elapsed in between two sleep intervals within a Beacon interval.

According to other embodiments, unassociated STAs may perform passive or active scanning only during the STAs service availability periods, but not within the duration indicated for TWTs and Trigger frame transmissions. To such an end, a STA can include an apparatus such as apparatus 1200 shown in FIG. 12. As illustrated, the apparatus 1200 can include a scanning signaling unit 1214 that can monitor an availability schedule, which can be retained in schedule(s) 624, in order to determine a service availability period of the STA. As mentioned, in response to the STA operating within such a period, the scanning signaling unit 1214 can direct the STA (e.g., can send an interruption control signal or other types of instructions to the STA) to perform a scan of the surrounding wireless environment. A radio unit 514 (not shown in FIG. 12) and a communication unit 526 can be utilized or otherwise leveraged for such a scanning. In addition or in another embodiment, multi long-term schedules and short-term schedules availability patterns (e.g., periodic arrangement of availability periods) can be used for efficient active scanning phases. For instance, the scanning signaling unit 1214 also can monitor such schedules, as configured for the STA, in order to determine an instant or a period at which the STA is permitted scan the surrounding wireless environment.

Further or in yet other embodiments, an AP device including the apparatus 1200 or similar apparatuses described herein can advertise active scanning phases in broadcast frames (DTIM Beacons) or Neighbor Report frames, for example, in order to control the scanning at a remote device (a STA or an IoT device). Therefore, in one aspect, unassociated STAs may decode Beacons or Neighbor reports from the AP device, and can wake up during those phases for active scanning. As such, power conservation can be achieved or otherwise improved. As described herein, in some embodiments, a STA can negotiate with an AP device or another STA on specific (per this STA or groups of STAs, for example) multi long-term and short-term schedules patterns. Such negotiation can be performed in accordance with aspects described herein. The signal may define the mutual short and long term multi TWT start times and durations availability period. In another embodiment, the STA or another STA can request an AP device or other STA(s) to modify, for example to end the current availability period or modify the next availability period, specific availability period parameters. According to one example embodiment, two or more APs and STAs may negotiate and establish a synchronized multi long-term and short-term schedules availability patterns, these patterns can assist, for example, a STA to remain connected or to be served anonymously, simultaneously by more than one AP device. Such coordination can be done using dedicated management coordination signaling between the entities and/or to a central coordination entity. In some implementations, a component such as the scanning signaling unit 1214 can be utilized or otherwise leveraged to send, receive, or exchange coordination messages amongst devices.

### EXAMPLE EMBODIMENTS

One example embodiment is a first device including a transceiver configured to transmit and receive wireless signals, an antenna coupled to the transceiver, one or more processors in communication with the transceiver, at least one memory that stores computer-executable instructions, and at least one processor of the one or more processors configured to access the at least one memory, wherein the at least one processor of the one or more processors is configured to execute the computer-executable instructions to cause to broadcast to one or more second devices, a first availability schedule of the first device, identify, in response to broadcasting the first availability schedule, a second availability schedule of the one or more second devices, determine the second availability schedule is different from the first availability schedule, and add the second availability schedule to the first availability schedule.

Adding the second availability schedule to the first availability schedule includes synchronizing the first availability schedule and the second availability schedule. Adding the second availability schedule to the first availability schedule includes modifying the first availability schedule to match the second availability schedule. The first availability schedule includes sleep times or wake-up times of an access point, and the second availability schedule includes sleep times or wake-up times of an internet of things (IoT) device. The first availability schedule or the second availability schedule includes a short term availability schedule or a long term availability schedule. The long term availability schedule may be broadcasted using a narrow band broadcast frame and the short term availability schedule may be broadcasted using a non-narrow band broadcast frame. The first device includes an access point, a sensor hub or an access gateway. The second device includes a sensor for detecting pressure, temperature, motion, humidity, carbon monoxide, or smoke.

Another example embodiment is a non-transitory computer-readable medium storing computer-executable instructions which, when executed by a processor, cause the processor to perform operations including causing to broadcast to one or more second devices, a first availability schedule of a first device, identifying, in response to broadcasting the first availability schedule, a second availability schedule of the one or more second devices, determining the second availability schedule is different from the first availability schedule, and adding the second availability schedule to the first availability schedule.

Adding the second availability schedule to the first availability schedule includes synchronizing the first availability schedule and the second availability schedule. Adding the second availability schedule to the first availability schedule includes modifying the first availability schedule to match the second availability schedule. The first availability schedule includes sleep times or wake-up times of an access point, and the second availability schedule includes sleep times or wake-up times of an internet of things (IoT) device. The first availability schedule or the second availability schedule includes a short term availability schedule or a long term availability schedule. The long term availability schedule may be broadcasted using a narrow band broadcast frame and the short term availability schedule may be broadcasted using a non-narrow band broadcast frame. The first device includes an access point, a sensor hub or an access gateway. The second device includes a sensor for detecting pressure, temperature, motion, humidity, carbon monoxide, or smoke.

Another example embodiment is a method including causing to broadcast to one or more second devices, a first availability schedule of a first device, identifying, in response to broadcasting the first availability schedule, a second availability schedule of the one or more second devices, determining the second availability schedule is different from the first availability schedule, and adding the second availability schedule to the first availability schedule. Adding the second availability schedule to the first availability schedule includes synchronizing the first availability schedule and the second availability schedule. Adding the second availability schedule to the first availability schedule includes modifying the first availability schedule to match the second availability schedule. The first availability schedule includes sleep times or wake-up times of an access point, and the second availability schedule includes sleep times or wake-up times of an internet of things (IoT) device. The first availability schedule or the second availability schedule includes a short term availability schedule or a long term availability schedule. The long term availability schedule may be broadcasted using a narrow band broadcast frame and the short term availability schedule may be broadcasted using a non-narrow band broadcast frame. The first device includes an access point, a sensor hub or an access gateway. The second device includes a sensor for detecting pressure, temperature, motion, humidity, carbon monoxide, or smoke.

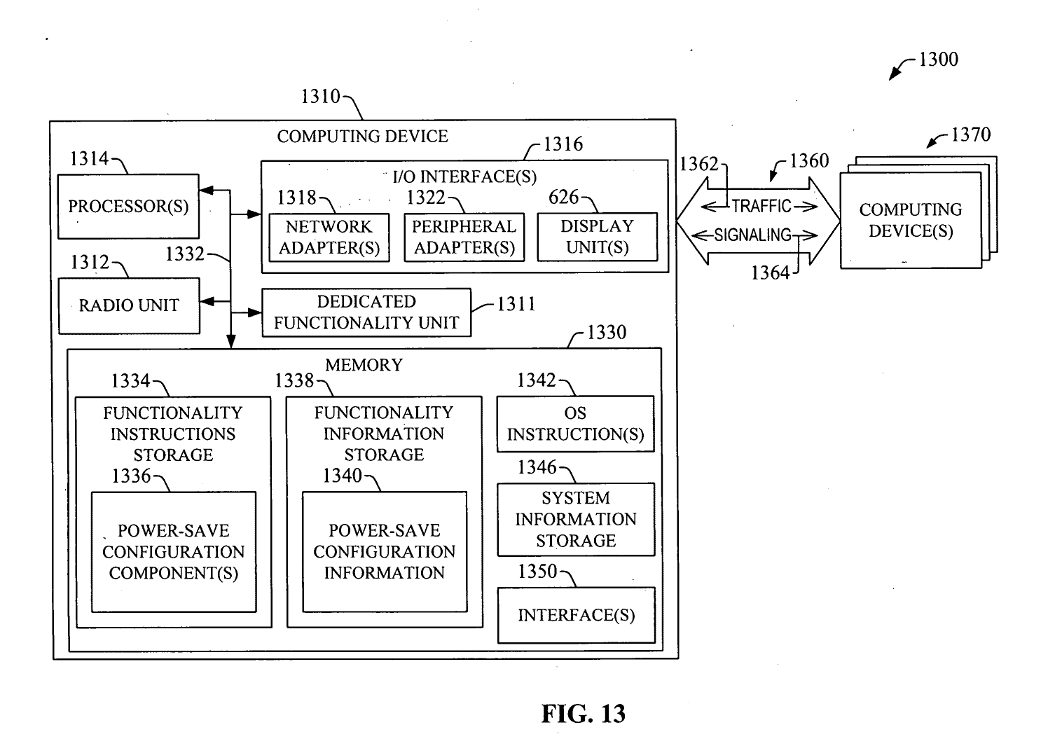

FIG. 13 illustrates an example of a computational environment 1300 for wireless communication in accordance with one or more aspects of the disclosure. The example computational environment 1300 is only illustrative and is not intended to suggest or otherwise convey any limitation as to the scope of use or functionality of such computational environments' architecture. In addition, the computational environment 1300 should not be interpreted as having any dependency or requirement relating to any one or combination of components illustrated in this example computational environment. The illustrative computational environment 1300 can embody or can include, for example, a device included in the example mesh network 200, one or more of the devices 116a or 116b, and/or any other computing device (e.g., device 510) that can implement or otherwise leverage the mechanisms for channel update and aspects thereof described herein. In some embodiments, the computing device 1310 can embody or can include any one of the devices in a low-power mesh network, such as the example mesh network 220 in FIG. 2. As such, the computing device 1310 can embody a border router, a router, a leader device, or a SED. In other embodiments, the computing device can embody or can include the AP device 210 or any of the devices in the operational environment 100 in FIG. 1.

The computational environment 1300 represents an example of a software implementation of the various aspects or features of the disclosure in which the processing or execution of operations described in connection with the mechanism for channel update for a communication channel of a sleepy end device in a thread network or other types of low-power networks, in accordance with aspects described herein can be performed in response to execution of one or more software components at the computing device 1310. It should be appreciated that the one or more software components can render the computing device 1310, or any other computing device that contains such components, a particular machine for channel update for a communication channel of a sleepy end device in a thread network or other types of low-power networks, in accordance with aspects described herein, among other functional purposes. A software component can be embodied in or can comprise one or more computer-accessible instructions, e.g., computer-readable and/or computer-executable instructions. At least a portion of the computer-accessible instructions can embody one or more of the example techniques disclosed herein. For instance, to embody one such method, at least the portion of the computer-accessible instructions can be persisted (e.g., stored, made available, or stored and made available) in a computer storage non-transitory medium and executed by a processor. The one or more computer-accessible (or processor-accessible) instructions that embody a software component can be assembled into one or more program modules, for example, that can be compiled, linked, and/or executed at the computing device 1310 or other computing devices. Generally, such program modules comprise computer code, routines, programs, objects, components, information structures (e.g., data structures and/or metadata structures), etc., that can perform particular tasks (e.g., one or more operations) in response to execution by one or more processors, which can be integrated into the computing device 1310 or functionally coupled thereto.

The various example embodiments of the disclosure can be operational with numerous other general purpose or special purpose computing system environments or configurations. Examples of well-known computing systems, environments, and/or configurations that can be suitable for implementation of various aspects or features of the disclosure in connection with mechanisms for channel update of communication channel of a sleepy end device can comprise personal computers; server computers; laptop devices; handheld computing devices, such as mobile tablets; wearable computing devices; and multiprocessor systems. Additional examples can include set top boxes, programmable consumer electronics, network PCs, minicomputers, mainframe computers, blade computers, programmable logic controllers, distributed computing environments that comprise any of the above systems or devices, and the like.

As illustrated, the computing device 1310 can include one or more processors 1314, one or more input/output (I/O) interfaces 1316, a memory 1330, and a bus architecture 1332 (also termed bus 1332) that functionally couples various functional elements of the computing device 1310. As illustrated, the computing device 1310 also can include a radio unit 1312. In one example, similarly to the radio unit 514, the radio unit 1312 can include one or more antennas and a communication processing unit that can permit wireless communication between the computing device 1310 and another device, such as one of the computing device(s) 1370. The computing device 1310 also can include, in at least some embodiments, a dedicate functionality unit 811 that can provide specific functionality to the computing device 810, similarly to the dedicated functionality unit 522 described hereinbefore. The bus 1332 can include at least one of a system bus, a memory bus, an address bus, or a message bus, and can permit exchange of information (data, metadata, and/or signaling) between the processor(s) 1314, the I/O interface(s) 1316, and/or the memory 1330, or respective functional element therein. In some scenarios, the bus 1332 in conjunction with one or more internal programming interfaces 1350 (also referred to as interface(s) 1350) can permit such exchange of information. In scenarios in which processor(s) 1314 include multiple processors, the computing device 1310 can utilize parallel computing.

The I/O interface(s) 1316 can permit or otherwise facilitate communication of information between the computing device and an external device, such as another computing device, e.g., a network element or an end-user device. Such communication can include direct communication or indirect communication, such as exchange of information between the computing device 1310 and the external device via a network or elements thereof. As illustrated, the I/O interface(s) 1316 can comprise one or more of network adapter(s) 1318, peripheral adapter(s) 1322, and display unit(s) 1326. Such adapter(s) can permit or facilitate connectivity between the external device and one or more of the processor(s) 1314 or the memory 1330. In one aspect, at least one of the network adapter(s) 1318 can couple functionally the computing device 1310 to one or more computing devices 1370 via one or more traffic and signaling pipes 1360 that can permit or facilitate exchange of traffic 1362 and signaling 1364 between the computing device 1310 and the one or more computing devices 1370. Such network coupling provided at least in part by the at least one of the network adapter(s) 1318 can be implemented in a wired environment, a wireless environment, or both. Therefore, it should be appreciated that in some embodiments, the functionality of the radio unit 1312 can be provided by a combination of at least one of the network adapter(s) 1318 and at least one of the processor(s) 1314. Accordingly, in such embodiments; the radio unit 1312 may not be included in the computing device 1310. The information that is communicated by the at least one network adapter can result from implementation of one or more operations in a method of the disclosure. Such output can be any form of visual representation, including, but not limited to, textual, graphical, animation, audio, tactile, and the like. In some scenarios, each of the computing device(s) 1370 can have substantially the same architecture as the computing device 1310. In addition or in the alternative, the display unit(s) 1326 can include functional elements (e.g., lights, such as light-emitting diodes; a display, such as liquid crystal display (LCD), combinations thereof, or the like) that can permit control of the operation of the computing device 1310, or can permit conveying or revealing operational conditions of the computing device 1310.

In one aspect, the bus 1332 represents one or more of several possible types of bus structures, including a memory bus or memory controller, a peripheral bus, an accelerated graphics port, and a processor or local bus using any of a variety of bus architectures. As an illustration, such architectures can comprise an Industry Standard Architecture (ISA) bus, a Micro Channel Architecture (MCA) bus, an Enhanced ISA (EISA) bus, a Video Electronics Standards Association (VESA) local bus, an Accelerated Graphics Port (AGP) bus, and a Peripheral Component Interconnects (PCI) bus, a PCI-Express bus, a Personal Computer Memory Card Industry Association (PCMCIA) bus, Universal Serial Bus (USB), and the like. The bus 1332, and all buses described herein can be implemented over a wired or wireless network connection and each of the subsystems, including the processor(s) 1314, the memory 1330 and memory elements therein, and the I/O interface(s) 1316 can be contained within one or more remote computing devices 1370 at physically separate locations, connected through buses of this form, in effect implementing a fully distributed system.

The computing device 1310 can comprise a variety of computer-readable media. Computer readable media can be any available media (transitory and non-transitory) that can be accessed by a computing device. In one aspect, computer-readable media can comprise computer non-transitory storage media (or computer-readable non-transitory storage media) and communications media. Example computer-readable non-transitory storage media can be any available media that can be accessed by the computing device 1310, and can comprise, for example, both volatile and non-volatile media, and removable and/or non-removable media. In one aspect, the memory 1330 can comprise computer-readable media in the form of volatile memory, such as random access memory (RAM), and/or non-volatile memory, such as read only memory (ROM).

The memory 1330 can comprise functionality instructions storage 1334 and functionality information storage 1338. The functionality instructions storage 1334 can comprise computer-accessible instructions that, in response to execution (by at least one of the processor(s) 1314), can implement one or more of the functionalities of the disclosure. The computer-accessible instructions can embody or can comprise one or more software components illustrated as power-save configuration component(s) 1336. In one scenario, execution of at least one component of the power-save configuration component(s) 1336 can implement one or more of the techniques disclosed herein. For instance, such execution can cause a processor that executes the at least one component to carry out a disclosed example method. It should be appreciated that, in one aspect, a processor of the processor(s) 1314 that executes at least one of the power-save configuration component(s) 1336 can retrieve information from or retain information in one or more memory elements 1340 (collectively referred to as power-save configuration information 1340) in the functionality information storage 1338 in order to operate in accordance with the functionality programmed or otherwise configured by the power-save configuration component(s) 1336. Such information can include at least one of code instructions, information structures, or the like. At least one of the one or more interfaces 1350 (e.g., application programming interface(s)) can permit or facilitate communication of information between two or more components within the functionality instructions storage 1334. The information that is communicated by the at least one interface can result from implementation of one or more operations in a method of the disclosure. In some embodiments, one or more of the functionality instructions storage 1334 and the functionality information storage 1338 can be embodied in or can comprise removable/non-removable, and/or volatile/non-volatile computer storage media.

At least a portion of at least one of the power-save configuration component(s) 1336 or power-save configuration information 1340 can program or otherwise configure one or more of the processors 1314 to operate at least in accordance with the functionality described herein. One or more of the processor(s) 1314 can execute at least one of such components and leverage at least a portion of the information in the storage 1338 in order to provide mechanisms for channel update for a communication channel of a sleepy end device in a thread network or other types of low-power networks (wireless or otherwise), in accordance with one or more aspects described herein. More specifically, yet not exclusively, in some implementations, execution of one or more of the component(s) 1336 can permit transmitting and/or receiving information at the computing device 1310, where the at least a portion of the information includes a directive to change a communication channel of a SED in accordance with aspects of this disclosure. As such, it should be appreciated that in some embodiments, a combination of the processor(s) 1314, the power-save configuration component(s) 1336, and the power-save configuration information 1340 can form means for providing specific functionality for mechanisms for power conservation in a low-power wireless network or other types of networks (wireless or otherwise), in accordance with one or more aspects of the disclosure.

It should be appreciated that, in some scenarios, the functionality instruction(s) storage 1334 can embody or can comprise a computer-readable non-transitory storage medium having computer-accessible instructions that, in response to execution, cause at least one processor (e.g., one or more of processor(s) 1314) to perform a group of operations comprising the operations or blocks described in connection with the disclosed techniques for updating a communication channel of a device in a low-power mesh network in accordance with this disclosure.

In addition, the memory 1330 can comprise computer-accessible instructions and information (e.g., data and/or metadata) that permit or facilitate operation and/or administration (e.g., upgrades, software installation, any other configuration, or the like) of the computing device 1310. Accordingly, as illustrated, the memory 1330 can comprise a memory element 1342 (labeled OS instruction(s) 1342) that contains one or more program modules that embody or include one or more OSs, such as Windows operating system, Unix, Linux, Symbian, Android, Chromium, and substantially any OS suitable for mobile computing devices or tethered computing devices. In one aspect, the operational and/or architecture complexity of the computing device 1310 can dictate a suitable OS. The memory 1330 also comprises a system information storage 1346 having data and/or metadata that permits or facilitate operation and/or administration of the computing device 1310. Elements of the OS instruction(s) 1342 and the system information storage 1346 can be accessible or can be operated on by at least one of the processor(s) 1314.

It should be recognized that while the functionality instructions storage 1334 and other executable program components, such as the operating system instruction(s) 1342, are illustrated herein as discrete blocks, such software components can reside at various times in different memory components of the computing device 1310, and can be executed by at least one of the processor(s) 1314. In some scenarios, an implementation of the power-save configuration component(s) 1336 can be retained on or transmitted across some form of computer readable media.

The computing device 1310 and/or one of the computing device(s) 1370 can include a power supply (not shown), which can power up components or functional elements within such devices. The power supply can be a rechargeable power supply, e.g., a rechargeable battery, and it can include one or more transformers to achieve a power level suitable for operation of the computing device 1310 and/or one of the computing device(s) 1370, and components, functional elements, and related circuitry therein. In some scenarios, the power supply can be attached to a conventional power grid to recharge and ensure that such devices can be operational. In one aspect, the power supply can include an I/O interface (e.g., one of the network adapter(s) 1318) to connect operationally to the conventional power grid. In another aspect, the power supply can include an energy conversion component, such as a solar panel, to provide additional or alternative power resources or autonomy for the computing device 1310 and/or one of the computing device(s) 1370.

The computing device 1310 can operate in a networked environment by utilizing connections to one or more remote computing devices 1370. As an illustration, a remote computing device can be a personal computer, a portable computer, a server, a router, a network computer, a peer device or other common network node, and so on. As described herein, connections (physical and/or logical) between the computing device 1310 and a computing device of the one or more remote computing devices 1370 can be made via one or more traffic and signaling pipes 1360, which can comprise wireline link(s) and/or wireless link(s) and several network elements (such as routers or switches, concentrators, servers, and the like) that form a PAN, a LAN, a WAN, a WPAN, a WLAN, and/or a WWAN. Such networking environments are conventional and commonplace in dwellings, offices, enterprise-wide computer networks, intranets, local area networks, and wide area networks.

It should be appreciated that portions of the computing device 1310 can embody or can constitute an apparatus. For instance, at least one of the processor(s) 1314; at least a portion of the memory 1330, including a portion of the power-save configuration component(s) 1336 and a portion of the power-save configuration information 1340; and at least a portion of the bus 1332 can embody or can constitute an apparatus that can operate in accordance with one or more aspects of this disclosure.

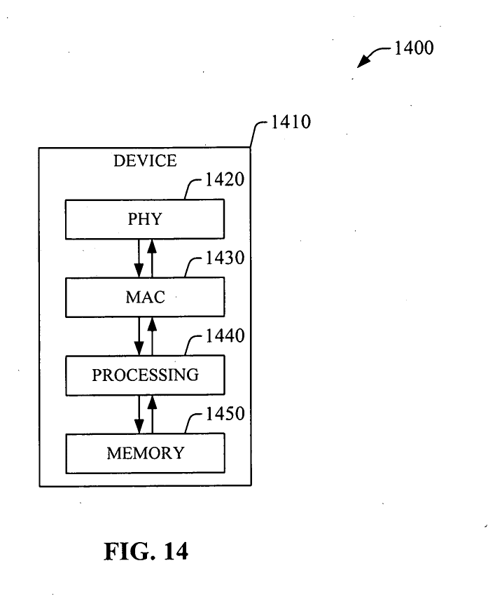

FIG. 14 presents another example embodiment 1400 of a device 1410 in accordance with one or more embodiments of the disclosure. The device 1410 can embody or can include, for example, one of the communication devices 110a, 110b, or 110c; one or more of the base stations 114a, 114b, or 114c; and/or any other devices (e.g., device 410) that implements or otherwise leverages power-saving operations (or, in some cases, power-saving techniques) in accordance with aspects described herein. In some embodiments, the device 1410 can embody or can include any one of the devices in a low-power mesh network, such as the example mesh network 220 in FIG. 2. As such, the device 1410 can embody a border router, a router, a leader device, or a SED. In some embodiments, the device 1410 can be a device compliant with IEEE 802.15.4 and/or Thread protocols that may be configured to communicate with one or more other similarly compliant devices and/or other types of communication devices, such as legacy communication devices. In addition or in other embodiments, the device 1410 can be compliant with Wi-Fi protocols and/or Thread protocols. Devices compliant with IEEE 802.15.4 and/or Thread protocols may be broadly referred to as Thread devices and can operate in accordance with aspects described herein. As mentioned, Thread devices, such as border routers, also may operate in accordance with Wi-Fi protocols. In one implementation, the device 1410 can operate as a commissioner device, a border router, a leader, a router, or a SED. As illustrated, the device 1410 can include, among other things, physical layer (PHY) circuitry 1120 and media access control layer (MAC) circuitry 1430. In one aspect, the PHY circuitry 1410 and the MAC circuitry 1430 can be layers compliant with IEEE 802.15.4 and/or Thread protocols, and also can be compliant, in some embodiments, with one or more Wi-Fi protocols, such as the family of IEEE 802.11 standards. In one aspect, the MAC circuitry 1430 can be arranged to configure physical layer converge protocol (PLCP) protocol data units (PPDUs) and arranged to transmit and receive PPDUs, among other things. In addition or in other embodiments, the device 1410 also can include other hardware processing circuitry 1440. (e.g., one or more processors) and one or more memory devices 1450 configured to perform the various operations described herein.

In some embodiments, the MAC circuitry 1430 can be arranged to contend for a wireless medium during a contention period to receive control of the medium for a control period and configure a PPDU. In addition or in other embodiments, the PHY circuitry 1420 can be arranged to transmit the PPDU. The PHY circuitry 1420 can include circuitry for modulation/demodulation, upconversion/downconversion, filtering, amplification, etc. As such, the device 1410 can include a transceiver to transmit and receive data such as PPDU. In some embodiments, the hardware processing circuitry 1440 can include one or more processors. The hardware processing circuitry 1440 can be configured to perform functions based on instructions being stored in a memory device (e.g., RAM or ROM) or based on special purpose circuitry. In some embodiments, the hardware processing circuitry 1440 can be configured to perform one or more of the functions described herein, such as allocating bandwidth or receiving allocations of bandwidth.

In some embodiments, one or more antennas may be coupled to or included in the PHY circuitry 1420. The antenna(s) can transmit and receive wireless signals, including transmission of HEW packets or other type of radio packets. As described herein, the one or more antennas can include one or more directional or omnidirectional antennas, including dipole antennas, monopole antennas, patch antennas, loop antennas, microstrip antennas or other types of antennas suitable for transmission of RF signals. In scenarios in which MIMO communication is utilized, the antennas may be physically separated to leverage spatial diversity and the different channel characteristics that may result.

The memory 1450 can retain or otherwise store information for configuring the other circuitry to perform operations for configuring and transmitting packets compliant with Thread protocols and/or other types of radio packets, and performing the various operations described herein including, for example, changing communication channels of a SED in accordance with one or more embodiments of this disclosure.

The device 1410 can be configured to communicate using OFDM communication signals over a multicarrier communication channel. More specifically, in some embodiments, the device 1410 can be configured to communicate in accordance with one or more specific radio technology protocols, such as the IEEE family of standards including IEEE 802.11, IEEE 802.11n, IEEE 802.11 ac, IEEE 802.11ax, IEEE 802.15.4, DensiFi, and/or proposed specifications for WLANs. In one of such embodiments, the device 1410 can utilize or otherwise rely on symbols having a duration that is four times the symbol duration of IEEE 802.11n and/or IEEE 802.11ac. It should be appreciated that the disclosure is not limited in this respect and, in some embodiments, the device 1410 also can transmit and/or receive wireless communications in accordance with other protocols and/or standards.

The device 1410 can be embodied in or can constitute a portable wireless communication device, such as a personal digital assistant (PDA), a laptop or portable computer with wireless communication capability, a web tablet, a wireless telephone, a smartphone, a wireless headset, a pager, an instant messaging device, a digital camera, an access point, a television, a medical device (e.g., a heart rate monitor, a blood pressure monitor, etc.), an access point, a base station, a transmit/receive device for a wireless standard such as IEEE 802.11, IEEE 802.15.4, or IEEE 802.16, or other types of communication device that may receive and/or transmit information wirelessly. Similarly to the computing device 1310, the device 1410 can include, for example, one or more of a keyboard, a display, a non-volatile memory port, multiple antennas, a graphics processor, an application processor, speakers, and other mobile device elements. The display may be an LCD screen including a touch screen.

It should be appreciated that while the device 1410 is illustrated as having several separate functional elements, one or more of the functional elements may be combined and may be implemented by combinations of software-configured elements, such as processing elements including digital signal processors (DSPs), and/or other hardware elements. For example, some elements may comprise one or more microprocessors, DSPs, field-programmable gate arrays (FPGAs), application specific integrated circuits (ASICs), radio-frequency integrated circuits (RFICs) and combinations of various hardware and logic circuitry for performing at least the functions described herein. In some embodiments, the functional elements may refer to one or more processes operating or otherwise executing on one or more processors. It should further be appreciated that portions of the device 1410 can embody or can constitute an apparatus. For instance, the processing circuitry 1440 and the memory 1450 can embody or can constitute an apparatus that can operate in accordance with one or more aspects of this disclosure. The apparatus also can include functional elements (e.g., a bus architecture and/or API(s) as described herein) that can permit exchange of information between the processing circuitry 1440 and the memory 1450.

According to example embodiments of the disclosure, there may be a device. The device may include at least one memory that stores computer-executable instructions and at least one processor. The at least one memory and the at least one processor may be configured to access the at least one memory and further be configured to execute the computer-executable instructions to: direct the device to send an availability schedule; receive a second availability schedule of a second device in response to transmission of the availability schedule; determine that the second availability schedule is different from the first availability schedule; and negotiate a mutual availability schedule with the second device. In example embodiments, the availability schedule may be a short-term availability schedule, and wherein to direct the device to send the availability schedule, the at least one processor is further configured to execute the instructions to direct the device to send a broadcast frame comprising information indicative of the short-term availability schedule. In further example embodiments, may be a long-term availability schedule, and to direct the device to send the availability schedule, the at least one processor may be further configured to execute the instructions to direct the device to send a narrowband broadcast frame within a narrowband portion of a communication channel, the broadcast frame comprising information indicative of the long-term availability schedule. In still further example embodiments, the at least one processor may be further configured to execute the instructions to receive a request for the availability schedule from a third device; and to direct the device to send a unicast frame comprising the availability schedule to the third device. In some further example embodiments, the at least one processor may be configured to execute the instructions to receive a request to modify the availability schedule, wherein the request may include at least one of a first request to terminate a current availability period or a second request to update a next availability period. In still further example embodiments, the at least one processor may be further configured to execute the instructions to send a frame to a third device, and the frame may include one of a broadcast frame or a neighbor report frame, the frame triggers scanning of wireless signal at the third device. In still further example embodiments, to negotiate the mutual availability schedule, the at least one processor may be further configured to execute the instructions to modify the availability schedule to match the second availability schedule; and to assign the modified availability scheduled to the mutual availability schedule. In still further example embodiments, to negotiate the mutual availability schedule, the at least one processor may be further configured to execute the instructions to cause the device to send, to the second device, a request to modify the second availability schedule. In still further example embodiments the availability schedule may include at least one of sleep times or wakeup times, and the second availability schedule may include at least one′ of sleep times or wakeup times. In still further example embodiments, the second availability schedule may include at least one of a short term availability schedule or a long term availability schedule. In still further example embodiments, the device may include an access point device, a sensor hub device, or an access gateway device. In still further example embodiments, the second device may include one of a first sensor for detecting pressure, a second sensor for detecting temperature, a third sensor for detecting motion, a fourth sensor for detecting humidity, a fifth sensor for detecting carbon monoxide, or a sixth sensor for detecting smoke.

According to example embodiments of the disclosure, there may be a device. The device may include at least one memory that stores computer-executable instructions and at least one processor. The at least one memory and the at least one processor may be configured to access the at least one memory and further be configured to execute the computer-executable instructions to: cause the device to send an availability schedule; receive a second availability schedule of a second device; coordinate the availability schedule with the second availability schedule, resulting in a coordinated availability schedule; and update the availability schedule according to the synchronized availability schedule.

According to example embodiments of the disclosure, there may be a device. The device may include at least one memory that stores computer-executable instructions and at least one processor. The at least one memory and the at least one processor may be configured to access the at least one memory and further be configured to execute the computer-executable instructions to: access an availability schedule comprising defined wakeup periods; and cause the device to scan for wireless signal at a time different from a second time within one of the defined wakeup periods. In further example embodiments, the at least one processor may be further configured to execute the instructions to receive a frame that triggers scanning of wireless signal, and the frame may include one of a broadcast frame or a neighbor report frame.

According to example embodiments of the disclosure, there may be a device. The device may include at least one memory that stores computer-executable instructions and at least one processor. The at least one memory and the at least one processor may be configured to access the at least one memory and further be configured to execute the computer-executable instructions to: access an availability schedule comprising wakeup periods and power-save periods; configure a frame comprising information indicative of the availability schedule; and direct the device to send the frame to at least one second device. In further example embodiments, the at least one second device may include a group of devices, each associated to the device, and device may send the frame to the at least one second device, the at least one processor being further configured to execute the instructions to broadcast the frame in a narrowband portion of a communication channel to the group of devices. In some further example embodiments, the at least one second device may include a group of devices, each associated to the device, and the device may send the frame to the at least one second device, the at least one processor further being configured to execute the instructions to multicast the frame in a narrowband portion of a communication channel to a subset of the group of devices. In still further example embodiments, the device may send the frame to the at least one second device, the at least one processor being further configured to execute the instructions to send a unicast frame in a narrowband portion of a communication channel to a defined second device of the at least one second device.

According to example embodiments of the disclosure, there may be a device. The device may include at least one memory that stores computer-executable instructions and at least one processor. The at least one memory and the at least one processor may be configured to access the at least one memory and further be configured to execute the computer-executable instructions to: direct the device to send an availability schedule; receive a second availability schedule of a second device in response to transmission of the availability schedule; determine that the second availability schedule is different from the first availability schedule; and negotiate a mutual availability schedule with the second device. In example embodiments, the availability schedule may be a short-term availability schedule, and wherein to direct the device to send the availability schedule, the at least one processor is further configured to execute the instructions to direct the device to send a broadcast frame comprising information indicative of the short-term availability schedule. In further example embodiments, may be a long-term availability schedule, and to direct the device to send the availability schedule, the at least one processor may be further configured to execute the instructions to direct the device to send a narrowband broadcast frame within a narrowband portion of a communication channel, the broadcast frame comprising information indicative of the long-term availability schedule. In still further example embodiments, the at least one processor may be further configured to execute the instructions to receive a request for the availability schedule from a third device; and to direct the device to send a unicast frame comprising the availability schedule to the third device. In some further example embodiments, the at least one processor may be configured to execute the instructions to receive a request to modify the availability schedule, wherein the request may include at least one of a first request to terminate a current availability period or a second request to update a next availability period. In still further example embodiments, the at least one processor may be further configured to execute the instructions to send a frame to a third device, and the frame may include one of a broadcast frame or a neighbor report frame, the frame triggers scanning of wireless signal at the third device. In still further example embodiments, to negotiate the mutual availability schedule, the at least one processor may be further configured to execute the instructions to modify the availability schedule to match the second availability schedule; and to assign the modified availability scheduled to the mutual availability schedule. In still further example embodiments, to negotiate the mutual availability schedule, the at least one processor may be further configured to execute the instructions to cause the device to send, to the second device, a request to modify the second availability schedule. In still further example embodiments the availability schedule may include at least one of sleep times or wakeup times, and the second availability schedule may include at least one of sleep times or wakeup times. In still further example embodiments, the second availability schedule may include at least one of a short term availability schedule or a long term availability schedule. In still further example embodiments, the device may include an access point device, a sensor hub device, or an access gateway device. In still further example embodiments, the second device may include one of a first sensor for detecting pressure, a second sensor for detecting temperature, a third sensor for detecting motion, a fourth sensor for detecting humidity, a fifth sensor for detecting carbon monoxide, or a sixth sensor for detecting smoke.

According to example embodiments of the disclosure, there may be a device. The device may include at least one memory that stores computer-executable instructions and at least one processor. The at least one memory and the at least one processor may be configured to access the at least one memory and further be configured to execute the computer-executable instructions to: cause the device to send an availability schedule; receive a second availability schedule of a second device; coordinate the availability schedule with the second availability schedule, resulting in a coordinated availability schedule; and update the availability schedule according to the synchronized availability schedule.

According to example embodiments of the disclosure, there may be a device. The device may include at least one memory that stores computer-executable instructions and at least one processor. The at least one memory and the at least one processor may be configured to access the at least one memory and further be configured to execute the computer-executable instructions to: access an availability schedule comprising defined wakeup periods; and cause the device to scan for wireless signal at a time different from a second time within one of the defined wakeup periods. In further example embodiments, the at least one processor may be further configured to execute the instructions to receive a frame that triggers scanning of wireless signal, and the frame may include one of a broadcast frame or a neighbor report frame.

According to example embodiments of the disclosure, there may be a device. The device may include at least one memory that stores computer-executable instructions and at least one processor. The at least one memory and the at least one processor may be configured to access the at least one memory and further be configured to execute the computer-executable instructions to: access an availability schedule comprising wakeup periods and power-save periods; configure a frame comprising information indicative of the availability schedule; and direct the device to send the frame to at least one second device. In further example embodiments, the at least one second device may include a group of devices, each associated, to the device, and device may send the frame to the at least one second device, the at least one processor being further configured to execute the instructions to broadcast the frame in a narrowband portion of a communication channel to the group of devices. In some further example embodiments, the at least one second device may include a group of devices, each associated to the device, and the device may send the frame to the at least one second device, the at least one processor further being configured to execute the instructions to multicast the frame in a narrowband portion of a communication channel to a subset of the group of devices. In still further example embodiments, the device may send the frame to the at least one second device, the at least one processor being further configured to execute the instructions to send a unicast frame in a narrowband portion of a communication channel to a defined second device of the at least one second device.

According to example embodiments of the disclosure, there may be a method. The method may include directing a device to send an availability schedule; receiving a second availability schedule of a second device in response to transmission of the availability schedule; determining that the second availability schedule is different from the first availability schedule; and negotiating a mutual availability schedule with the second device. In example embodiments, the availability schedule may be a short-term availability schedule, and wherein to direct the device to send the availability schedule, the method may further include directing the device to send a broadcast frame comprising information indicative of the short-term availability schedule. In further example embodiments, there, may be a long-term availability schedule, and the method may further include directing the device to send the availability schedule and directing the device to send a narrowband broadcast frame within a narrowband portion of a communication channel, the broadcast frame comprising information indicative of the long-term availability schedule. In still further example embodiments, the method may include receiving a request for the availability schedule from a third device; and directing the device to send a unicast frame comprising the availability schedule to the third device. In some further example embodiments, the method may include receiving a request to modify the availability schedule and the request may include at least one of a first request to terminate a current availability period or a second request to update a next availability period. In still further example embodiments, the method may include sending a frame to a third device and the frame may include one of a broadcast frame or a neighbor report frame, the frame triggers scanning of wireless signal at the third device. In still further example embodiments, to negotiate the mutual availability schedule, the method may include modifying the availability schedule to match the second availability schedule; and assigning the modified availability scheduled to the mutual availability schedule. In still further example embodiments, to negotiate the mutual availability schedule, the method may include causing the device to send, to the second device, a request to modify the second availability schedule. In still further example embodiments the availability schedule may include at least one of sleep times or wakeup times, and the second availability schedule may include at least one of sleep times or wakeup times. In still further example embodiments, the second availability schedule may include at least one of a short term availability schedule or a long term availability schedule. In still further example embodiments, the device may include an access point device, a sensor hub device, or an access gateway device. In still further example embodiments, the second device may include one of a first sensor for detecting pressure, a second sensor for detecting temperature, a third sensor for detecting motion, a fourth sensor for detecting humidity, a fifth sensor for detecting carbon monoxide, or a sixth sensor for detecting smoke.

According to example embodiments of the disclosure, there may be a method. The method may include causing a device to send an availability schedule; receiving a second availability schedule of a second device; coordinating the availability schedule with the second availability schedule, resulting in a coordinated availability schedule; and updating the availability schedule according to the synchronized availability schedule.

According to example embodiments of the disclosure, there may be a method. The method may include accessing an availability schedule comprising defined wakeup periods; and causing the device to scan for wireless signal at a time different from a second time within one of the defined wakeup periods. In further example embodiments, the method may include receiving a frame that triggers scanning of wireless signal, and the frame may include one of a broadcast frame or a neighbor report frame.

According to example embodiments of the disclosure, there may be a method. The method may include accessing an availability schedule comprising wakeup periods and power-save periods; configure a frame comprising information indicative of the availability schedule; and directing the device to send the frame to at least one second device. In further example embodiments, the at least one second device may include a group of devices, each associated to the device, and the device may send the frame to the at least one second device, the method further including broadcasting the frame in a narrowband portion of a communication channel to the group of devices. In some further example embodiments, the at least one second device may include a group of devices, each associated to the device, and the device may send the frame to the at least one second device, the method further including multicasting the frame in a narrowband portion of a communication channel to a subset of the group of devices. In still further example embodiments, the device may send the frame to the at least one second device, the method further including sending a unicast frame in a narrowband portion of a communication channel to a defined second device of the at least one second device.

According to example embodiments of the disclosure, there may be a computer-readable non-transitory storage medium that contains instructions, which when executed by one or more processors result in performing operations, including: directing a device to send an availability schedule; receiving a second availability schedule of a second device in response to transmission of the availability schedule; determining that the second availability schedule is different from the first availability schedule; and negotiating a mutual availability schedule with the second device. In example embodiments, the availability schedule may be a short-term availability schedule, and wherein to direct the device to send the availability schedule, the medium may further include directing the device to send a broadcast frame comprising information indicative of the short-term availability schedule. In further example embodiments, there may be a long-term availability schedule, and the medium may further include directing the device to send the availability schedule and directing the device to send a narrowband broadcast frame within a narrowband portion of a communication channel, the broadcast frame comprising information indicative of the long-term availability schedule. In still further example embodiments, the medium may include receiving a request for the availability schedule from a third device; and directing the device to send a unicast frame comprising the availability schedule to the third device. In some further example embodiments, the medium may include receiving a request to modify the availability schedule and the request may include at least one of a first request to terminate a current availability period or a second request to update a next availability period. In still further example embodiments, the medium may include sending a frame to a third device and the frame may include one of a broadcast frame or a neighbor report frame, the frame triggers scanning of wireless signal at the third device. In still further example embodiments, to negotiate the mutual availability schedule, the medium may include modifying the availability schedule to match the second availability schedule; and assigning the modified availability scheduled to the mutual availability schedule. In still further example embodiments, to negotiate the mutual availability schedule, the medium may include causing the device to send, to the second device, a request to modify the second availability schedule. In still further example embodiments the availability schedule may include at least one of sleep times or wakeup times, and the second availability schedule may include at least one of sleep times or wakeup times. In still further example embodiments, the second availability schedule may include at least one of a short term availability schedule or a long term availability schedule. In still further example embodiments, the device may include an access point device, a sensor hub device, or an access gateway device. In still further example embodiments, the second device may include one of a first sensor for detecting pressure, a second sensor for detecting temperature, a third sensor for detecting motion, a fourth sensor for detecting humidity, a fifth sensor for detecting carbon monoxide, or a sixth sensor for detecting smoke.

According to example embodiments of the disclosure, there may be a computer-readable non-transitory storage medium that contains instructions, which when executed by one or more processors result in performing operations, including: causing a device to send an availability schedule; receiving a second availability schedule of a second device; coordinating the availability schedule with the second availability schedule, resulting in a coordinated availability schedule; and updating the availability schedule according to the synchronized availability schedule.

According to example embodiments of the disclosure, there may be a computer-readable non-transitory storage medium that contains instructions, which when executed by one or more processors result in performing operations, including: accessing an availability schedule comprising defined wakeup periods; and causing a device to scan for wireless signal at a time different from a second time within one of the defined wakeup periods. In further example embodiments, the medium may include receiving a frame that triggers scanning of wireless signal, and the frame may include one of a broadcast frame or a neighbor report frame.

According to example embodiments of the disclosure, there may be a computer-readable non-transitory storage medium that contains instructions, which when executed by one or more processors result in performing operations, including: accessing an availability schedule comprising wakeup periods and power-save periods; configuring a frame comprising information indicative of the availability schedule; and directing a device to send the frame to at least one second device. In further example embodiments, the at least one second device may include a group of devices, each associated to the device, and the device may send the frame to the at least one second device, the medium further including broadcasting the frame in a narrowband portion of a communication channel to the group of devices. In some further example embodiments, the at least one second device may include a group of devices, each associated to the device, and the device may send the frame to the at least one second device, the medium further including multicasting the frame in a narrowband portion of a communication channel to a subset of the group of devices. In still further example embodiments, the device may send the frame to the at least one second device, the medium further including sending a unicast frame in a narrowband portion of a communication channel to a defined second device of the at least one second device.

According to example embodiments of the disclosure, there may be an apparatus. The apparatus may include means for: directing a device to send an availability schedule; receiving a second availability schedule of a second device in response to transmission of the availability schedule; determining that the second availability schedule is different from the first availability schedule; and negotiating a mutual availability schedule with the second device. In example embodiments, the availability schedule may be a short-term availability schedule, and wherein to direct the device to send the availability schedule, the apparatus may further include means for directing the device to send a broadcast frame comprising information indicative of the short-term availability schedule. In further example embodiments, there may be a long-term availability schedule, and the apparatus medium may further include means for directing the device to send the availability schedule and means for directing the device to send a narrowband broadcast frame within a narrowband portion of a communication channel, the broadcast frame comprising information indicative of the long-term availability schedule. In still further example embodiments, the apparatus may include means for receiving a request for the availability schedule from a third device; and means for directing the device to send a unicast frame comprising the availability schedule to the third device. In some further example embodiments, the apparatus may include means for receiving a request to modify the availability schedule and the request may include at least one of a first request to terminate a current availability period or a second request to update a next availability period. In still further example embodiments, the apparatus medium may include means for sending a frame to a third device and the frame may include one of a broadcast frame or a neighbor report frame, the frame triggers scanning of wireless signal at the third device. In still further example embodiments, to negotiate the mutual availability schedule, the apparatus may include means for modifying the availability schedule to match the second availability schedule; and assigning the modified availability scheduled to the mutual availability schedule. In still further example embodiments, to negotiate the mutual availability schedule, the apparatus may include means for causing the device to send, to the second device, a request to modify the second availability schedule. In still further example embodiments the availability schedule may include at least one of sleep times or wakeup times, and the second availability schedule may include at least one of sleep times or wakeup times. In still further example embodiments, the second availability schedule may include at least one of a short term availability schedule or a long term availability schedule. In still further example embodiments, the device may include an access point device, a sensor hub device, or an access gateway device. In still further example embodiments, the second device may include one of a first sensor for detecting pressure, a second sensor for detecting temperature, a third sensor for detecting motion, a fourth sensor for detecting humidity, a fifth sensor for detecting carbon monoxide, or a sixth sensor for detecting smoke.

According to example embodiments of the disclosure, there may be an apparatus comprising means for: causing a device to send an availability schedule; receiving a second availability schedule of a second device; coordinating the availability schedule with the second availability schedule, resulting in a coordinated availability schedule; and updating the availability schedule according to the synchronized availability schedule.

According to example embodiments of the disclosure, there may be an apparatus comprising means for: accessing an availability schedule comprising defined wakeup periods; and causing a device to scan for wireless signal at a time different from a second time within one of the defined wakeup periods. In further example embodiments, the apparatus may include means for receiving a frame that triggers scanning of wireless signal, and the frame may include one of a broadcast frame or a neighbor report frame.

According to example embodiments of the disclosure, there may be an apparatus comprising means for: accessing an availability schedule comprising wakeup periods and power-save periods; configuring a frame comprising information indicative of the availability schedule; and directing a device to send the frame to at least one second device. In further example embodiments, the at least one second device may include a group of devices, each associated to the device, and the device may send the frame to the at least one second device, the apparatus further including means for broadcasting the frame in a narrowband portion of a communication channel to the group of devices. In some further example embodiments, the at least one second device may include a group of devices, each associated to the device, and the device may send the frame to the at least one second device, the apparatus further including means for multicasting the frame in a narrowband portion of a communication channel to a subset of the group of devices. In still further example embodiments, the device may send the frame to the at least one second device, the apparatus further including means for sending a unicast frame in a narrowband portion of a communication channel to a defined second device of the at least one second device.

Various embodiments of the disclosure may take the form of an entirely or partially hardware embodiment, an entirely or partially software embodiment, or a combination of software and hardware (e.g., a firmware embodiment). Furthermore, as described herein, various embodiments of the disclosure (e.g., methods and systems) may take the form of a computer program product comprising a computer-readable non-transitory storage medium having computer-accessible instructions (e.g., computer-readable and/or computer-executable instructions) such as computer software, encoded or otherwise embodied in such storage medium. Those instructions can be read or otherwise accessed and executed by one or more processors to perform or permit performance of the operations described herein. The instructions can be provided in any suitable form, such as source code, compiled code, interpreted code, executable code, static code, dynamic code, assembler code, combinations of the foregoing, and the like. Any suitable computer-readable non-transitory storage medium may be utilized to form the computer program product. For instance, the computer-readable medium may include any tangible non-transitory medium for storing information in a form readable or otherwise accessible by one or more computers or processor(s) functionally coupled thereto. Non-transitory storage media can include read only memory (ROM); random access memory (RAM); magnetic disk storage media; optical storage media; flash memory, etc.

Embodiments of the operational environments and techniques (procedures, methods, processes, and the like) are described herein with reference to block diagrams and flowchart illustrations of methods, systems, apparatuses and computer program products. It can be understood that each block of the block diagrams and flowchart illustrations, and combinations of blocks in the block diagrams and flowchart illustrations, respectively, can be implemented by computer-accessible instructions. In certain implementations, the computer-accessible instructions may be loaded or otherwise incorporated into a general purpose computer, special purpose computer, or other programmable information processing apparatus to produce a particular machine, such that the operations or functions specified in the flowchart block or blocks can be implemented in response to execution at the computer or processing apparatus.

Blocks of the block diagrams and flow diagrams support combinations of means for performing the specified functions, combinations of elements or steps for performing the specified functions and program instruction means for performing the specified functions. It will also be, understood that each block of the block diagrams and flow diagrams, and combinations of blocks in the block diagrams and flow diagrams, may be implemented by special-purpose, hardware-based computer systems that perform the specified functions, elements or steps, or combinations of special-purpose hardware and computer instructions.

Unless otherwise expressly stated, it is in no way intended that any protocol, procedure, process, or method set forth herein be construed as requiring that its acts or steps be performed in a specific order. Accordingly, where a process or method claim does not actually recite an order to be followed by its acts or steps or it is not otherwise specifically recited in the claims or descriptions of the subject disclosure that the steps are to be limited to a specific order, it is in no way intended that an order be inferred, in any respect. This holds for any possible non-express basis for interpretation, including: matters of logic with respect to arrangement of steps or operational flow; plain meaning derived from grammatical organization or punctuation; the number or type of embodiments described in the specification or annexed drawings, or the like.

As used in this application, the terms “component,” “node,” “environment,” “system,” “architecture,” “interface,” “unit,” “engine,” “platform,” “module,” and the like are intended to refer to a computer-related entity or an entity related to an operational apparatus with one or more specific functionalities. Such entities may be either hardware, a combination of hardware and software, software, or software in execution. As an example, a component may be, but is not limited to being, a process running on a processor, a processor, an object, an executable portion of software, a thread of execution, a program, and/or a computing device. For example, both a software application executing on a computing device and the computing device can be a component. One or more components may reside within a process and/or thread of execution. A component may be localized on one device or distributed between two or more devices. As described herein, a component can execute from various computer-readable non-transitory media having various data structures stored thereon. Components can communicate via local and/or remote processes in accordance, for example, with a signal (either analog or digital) having one or more data packets (e.g., data from one component interacting with another component in a local system, distributed system, and/or across a network such as a wide area network with other systems via the signal). As another example, a component can be an apparatus with specific functionality provided by mechanical parts operated by electric or electronic circuitry that is controlled by a software application or firmware application executed by a processor, wherein the processor can be internal or external to the apparatus and can execute at least a part of the software or firmware application. As yet another example, a component can be an apparatus that provides specific functionality through electronic components without mechanical parts, the electronic components can include a processor therein to execute software or firmware that confers at least in part the functionality of the electronic components. An interface can include input/output (I/O) components as well as associated processor, application, and/or other programming components. The terms “component,” “environment,” “system,” “architecture,” “interface,” “unit,” “engine,” “platform,” “module” can be utilized interchangeably and can be referred to collectively as functional elements.

In the present specification and annexed drawings, reference to a “processor” is made. As utilized herein, a processor can refer to any computing processing unit or device comprising single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit (IC), an application-specific integrated circuit (ASIC), a digital signal processor (DSP), a field programmable gate array (FPGA), a programmable logic controller (PLC), a complex programmable logic device (CPLD), a reduced instruction set computing (RISC) microprocessor, a discrete gate or transistor logic, discrete hardware components, or any combination thereof designed to perform the functions described herein. A processor can be implemented as a combination of computing processing units. In certain embodiments, processors can utilize nanoscale architectures, such as molecular and quantum-dot based transistors, switches and gates, in order to optimize space usage or enhance performance of user equipment.

In addition, in the present specification and annexed drawings, terms such as “store,” storage,” “data store,” “data storage,” “memory,” “repository,” and substantially any other information storage component relevant to operation and functionality of a component of the disclosure, refer to “memory components,” entities embodied in a “memory,” or components forming the memory. It can be appreciated that the memory components or memories described herein embody or comprise non-transitory computer storage media that can be readable or otherwise accessible by a computing device. Such media can be implemented in any methods or technology for storage of information such as computer-readable instructions, information structures, program modules, or other information objects. The memory components or memories can be either volatile memory or non-volatile memory, or can include both volatile and non-volatile memory. In addition, the memory components or memories can be removable or non-removable, and/or internal or external to a computing device or component. Example of various types of non-transitory storage media can comprise hard-disc drives, zip drives, CD-ROM, digital versatile disks (DVD) or other optical storage, magnetic cassettes, magnetic tape, magnetic disk storage or other magnetic storage devices, flash memory cards or other types of memory cards, cartridges, or any other non-transitory medium suitable to retain the desired information and which can be accessed by a computing device.

As an illustration, non-volatile memory can include read only memory (ROM), programmable ROM (PROM), electrically programmable ROM (EPROM), electrically erasable ROM (EEPROM), or flash memory. Volatile memory can include random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). The disclosed memory components or memories of operational environments described herein are intended to comprise one or more of these and/or any other suitable types of memory.

Conditional language, such as, among others, “can,” “could,” “might,” or “may,” unless specifically stated otherwise, or otherwise understood within the context as used, is generally intended to convey that certain implementations could include, while other implementations do not include, certain features, elements, and/or operations. Thus, such conditional language generally is not intended to imply that features, elements, and/or operations are in any way required for one or more implementations or that one or more implementations necessarily include logic for deciding, with or without user input or prompting, whether these features, elements, and/or operations are included or are to be performed in any particular implementation.

What has been described herein in the present specification and annexed drawings includes examples of systems, devices, techniques, and computer program products that can provide power-saving architectures and techniques in wireless networks, including low-power wireless networks. It is, of course, not possible to describe every conceivable combination of elements and/or methods for purposes of describing the various elements of the disclosure, but it can be recognized that many further combinations and permutations of the disclosed features are possible. Accordingly, it may be apparent that various modifications can be made to the disclosure without departing from the scope or spirit thereof. In addition or in the alternative, other embodiments of the disclosure may be apparent from consideration of the specification and annexed drawings, and practice of the disclosure as presented herein. It is intended that the examples put forward in the specification and annexed drawings be considered, in all respects, as illustrative and not restrictive. Although specific terms are employed herein, they are used in a generic and descriptive sense only and not for purposes of limitation.

What is claimed is:

1. A device, comprising:
at least one memory device having instructions programmed thereon; and
at least one processor configured to access the at least one memory device and further configured to execute the instructions to:
direct the device to send an availability schedule;
receive a second availability schedule of a second device in response to transmission of the availability schedule;
determine that the second availability schedule is different from the first availability schedule; and
negotiate a mutual availability schedule with the second device.

2. The device of claim 1, wherein the availability schedule comprises a short-term availability schedule, and wherein to direct the device to send the availability schedule, the at least one processor is further configured to execute the instructions to direct the device to send a broadcast frame comprising information indicative of the short-term availability schedule.

3. The device of claim 1, wherein the availability schedule comprises a long-term availability schedule, and wherein to direct the device to send the availability schedule, the at least one processor is further configured to execute the instructions to direct the device to send a narrowband broadcast frame within a narrowband portion of a communication channel, the broadcast frame comprising information indicative of the long-term availability schedule.

4. The device of claim 1, wherein the at least one processor is further configured to execute the instructions to receive a request for the availability schedule from a third device; and
to direct the device to send a unicast frame comprising the availability schedule to the third device.

5. The device of claim 1, wherein the at least one processor is further configured to execute the instructions to receive a request to modify the availability schedule, wherein the request comprises at least one of a first request to terminate a current availability period or a second request to update a next availability period.

6. The device of claim 1, wherein the at least one processor is further configured to execute the instructions to send a frame to a third device, and wherein the frame comprises one of a broadcast frame or a neighbor report frame, the frame triggers scanning of wireless signal at the third device.

7. The device of claim 1, wherein to negotiate the mutual availability schedule, the at least one processor is further configured to execute the instructions to modify the availability schedule to match the second availability schedule; and
to assign the modified availability scheduled to the mutual availability schedule.

8. The device of claim 1, wherein to negotiate the mutual availability schedule, the at least one processor is further configured to execute the instructions to cause the device to send, to the second device, a request to modify the second availability schedule.

9. The device of claim 1, wherein the availability schedule comprises at least one of sleep times or wakeup times, and wherein the second availability schedule comprises at least one of sleep times or wakeup times.

10. The device of claim 1, wherein the second availability schedule comprises at least one of a short term availability schedule or a long term availability schedule.

11. The device of claim 1, wherein the device comprises an access point device, a sensor hub device, or an access gateway device.

12. The device of claim 1, wherein the second device comprises one of a first sensor for detecting pressure, a second sensor for detecting temperature, a third sensor for detecting motion, a fourth sensor for detecting humidity, a fifth sensor for detecting carbon monoxide, or a sixth sensor for detecting smoke.

13. A device, comprising:
at least one memory device having instructions programmed thereon; and
at least one processor configured to access the at least one memory device and further configured to execute the instructions to:
access an availability schedule comprising defined wakeup periods; and
cause the device to scan for wireless signal at a time different from a second time within one of the defined wakeup periods.

14. The device of claim 13, wherein the at least one processor is further configured to execute the instructions to receive a frame that triggers scanning of wireless signal, and wherein the frame comprises one of a broadcast frame or a neighbor report frame.

15. A device, comprising:
at least one memory device having instructions programmed thereon; and
at least one processor configured to access the at least one memory device and further configured to execute the instructions to:
access an availability schedule comprising wakeup periods and power-save periods;
configure a frame comprising information indicative of the availability schedule; and
direct the device to send the frame to at least one second device.

16. The device of claim 15, wherein the at least one second device comprises a group of devices, each associated to the device, and wherein to cause the device to send the frame to the at least one second device, the at least one processor is further configured to execute the instructions to broadcast the frame in a narrowband portion of a communication channel to the group of devices.

17. The device of claim 15, wherein the at least one second device comprises a group of devices, each associated to the device, and wherein to cause the device to send the frame to the at least one second device, the at least one processor is further configured to execute the instructions to multicast the frame in a narrowband portion of a communication channel to a subset of the group of devices.

18. The device of claim 15, wherein to cause the device to send the frame to the at least one second device, the at least one processor is further configured to execute the instructions to send a unicast frame in a narrowband portion of a communication channel to a defined second device of the at least one second device.

19. At least one computer-readable storage device having instructions encoded thereon that, in response to execution, direct a device to perform or facilitate operations comprising:
directing the device to send an availability schedule;
receiving a second availability schedule of a second device in response to transmission of the availability schedule;
determining that the second availability schedule is different from the first availability schedule; and
negotiating a mutual availability schedule with the second device.

20. The at least one computer-readable storage device of claim 19, wherein the availability schedule comprises a short-term availability schedule, and wherein to direct the device to send the availability schedule, the at least one processor is further configured to execute the instructions to direct the device to send a broadcast frame comprising information indicative of the short-term availability schedule.

21. The at least one computer-readable storage device of claim 19, wherein the availability schedule comprises a long-term availability schedule, and wherein to direct the device to send the availability schedule, the at least one processor is further configured to execute the instructions to direct the device to send a narrowband broadcast frame within a narrowband portion of a communication channel, the broadcast frame comprising information indicative of the long-term availability schedule.

22. The at least one computer-readable storage device of claim 19, wherein the operations further comprise receiving a request for the availability schedule from a third device; and
directing the device to send a unicast frame comprising the availability schedule to the third device.

23. The at least one computer-readable storage device of claim 19, wherein the operations further comprise receiving a request to modify the availability schedule, wherein the request comprises at least one of a first request to terminate a current availability period or a second request to update a next availability period.

24. The at least one computer-readable storage device of claim 19, wherein the operations further comprise sending a frame to a third device, and wherein the frame comprises one of a broadcast frame or a neighbor report frame, the frame triggering scanning of a wireless signal at the third device.

25. The at least one computer-readable storage device of claim 19, wherein the negotiating the mutual availability schedule comprises modifying the availability schedule to match the second availability schedule; and
assigning the modified availability scheduled to the mutual availability schedule.
